(19) United States
(12) Patent Application Publication
(10) Pub. No.: US 2026/0358676 A1
(43) Pub. Date: Nov. 12, 2026

(54) A FREQUENCY CONVERSION DEVICE FOR USE WITH AN INFRARED IMAGING SYSTEM

(71) Applicant: NOTTINGHAM TRENT UNIVERSITY, Nottingham (GB)

(72) Inventors: Ze ZHENG, Nottingham (GB); Lei XU, Nottingham (GB); Cuifeng YING, Nottingham (GB); Mohsen RAHMANI, Nottingham (GB)

(21) Appl. No.: 19/132,706

(22) PCT Filed: Nov. 16, 2023
(86) PCT No.: PCT/GB2023/053010

§ 371 Date: May 23, 2025

(30) Foreign Application Priority Data
Nov. 24, 2022 (GB) 2217608.5

(51) Int. Cl. G02F 1/35; G01N 21/17

(52) U.S. Cl. CPC G02F 1/3536; G01N 21/17; G02F 1/354; G01N 2021/1765; G01N 2201/068

(57) ABSTRACT

A frequency conversion device is designed for use with a detector for imaging a sample. It includes a structure made of a third-order susceptibility material adapted to convert a first beam of electromagnetic radiation having a first wavelength in the infrared region into an output beam having a wavelength of less than about 1000 nm via a nonlinear process. The third-order susceptibility material may be adapted to generate the output beam by mixing the first beam with at least one of a first pump beam having a second wavelength and a second pump beam having a third wavelength. An infrared imaging system uses the frequency conversion device.

### CROSS-REFERENCE TO RELATED APPLICATIONS

This application is a national stage application filed under 35 U.S.C. § 371 of PCT Application No. PCT/GB2023/053010, filed Nov. 16, 2023, which claims priority to United Kingdom patent application GB 2217608.5, filed Nov. 24, 2022, the entire disclosure of each of which is incorporated herein by reference.

### BACKGROUND OF THE DISCLOSURE

### 1. Field of the Disclosure

The present disclosure relates to a frequency conversion device for use with a detector for imaging a sample. The disclosure also relates to an infrared imaging system using the frequency conversion device and a corresponding method for imaging a sample.

### 2. Description of Related Art

Typical infrared (IR) detectors or thermal imagers form an image of an object on a photocathode, leading to a discharge of electrons. The electrons are multiplied and strike a phosphor screen. The phosphor screen luminesces, and the resultant visible image is viewed by the eye or by an imaging sensor. Such detectors are bulky, heavy and monochrome.

Infrared imaging and spectroscopy based on nonlinear metasurfaces has been suggested as a potential substitute for commercial IR imaging detectors, for instance see WO 2018/204991 and R. Camacho-Morales, et al., Advanced Photonics, 2021, 3, 036002.

These metasurfaces are formed of arrays of densely packed nanostructures designed to manipulate the properties of incident light, which can include its amplitude, directionality, phase, polarization, and frequency. The metasurfaces can also enable strong light concentration inside them to convert the frequency of an image. The use of this process for frequency conversion eliminates the need for conversion of the optical to the electronic domain.

WO 2018/204991 describes a frequency conversion device based on an array of semiconductors islands composed of a III-V semiconductor compound. III-V semiconductor compound are non-centro-symmetric materials which are employed for second order non-linear interactions, such as Second Harmonic Generation (SHG), and Sum Frequency Generation (SFG). The latter process (SFG) allows employing an extra laser (known as pump) beam to generate a new visible wave.

Yet existing approaches remain limited either due to a lack of tools to improve the conversion efficiency or by the inability to extend the coverage band to longer wavelength-IR (up to 50 μm). Some metasurfaces made of Silicon and Germanium have been demonstrated for third-order nonlinear interaction, such as Third-Harmonic-Generation (THG), or Four Wave-Mixing (FWM) see for instance S. Chen, et al., Acs Photonics, 2018, 5, 1671-1675; W. Tong, et al., Optics Express, 2016, 24, 19661-19670; M. P. Fischer, et al., Light: Science & Applications, 2018, 7, 1-7; L. Xu, et al., New Journal of Physics, 2022, 24, 035002.

A so called meta-lens has also been proposed (C. Schlickriede, S. S. Kruk, L. Wang, B. Sain, Y. Kivshar and T. Zentgraf, Nano Letters, 2020, 20, 4370-4376). This setup is limited to specific wavelengths and working distance. Also, it is not fully functioning if any part of the meta-lens is blocked.

However, no third order susceptibility metasurfaces have been designed and exploited for nonlinear imaging, to date. Currently, in order to detect visible, near-infrared (NIR), and mid-infrared (MIR) lights, one need three separate cameras that employ different technologies. While visible detectors/cameras, that detect up to 1000 nm, are small, low-power consumption, and inexpensive, the other two detectors (near-infrared, and mid-infrared) are much more expensive, and consume much more space and power.

It is an object of the disclosure to address one or more of the above mentioned limitations.

### SUMMARY OF THE DISCLOSURE

According to a first aspect of the disclosure, there is provided a frequency conversion device for use with a detector for imaging a sample; the frequency conversion device comprising a structure made of a third-order susceptibility material adapted to convert a first beam of electromagnetic radiation having a first wavelength in the infrared region into an output beam having a wavelength of less than about 1000 nm via a nonlinear process.

For example the frequency conversion device can be an upgrading component to expand the operational bandwidth of the detector.

The output beam can have one or more wavelengths of less than about 1000 nm obtained via one or more nonlinear processes such as four wave mixing or higher order mixing nonlinear processes.

Optionally, the third-order susceptibility material is adapted to generate the output beam by mixing the first beam with at least one of a first pump beam having a second wavelength and a second pump beam having a third wavelength.

Optionally, wherein at least one of the second wavelength of the first pump beam and the third wavelength of the second pump beam is greater than about 1000 nm. For instance, both the second and the third wavelengths can be greater than 1000 nm.

Optionally, the structure comprises an arrangement of individual elements, wherein each individual element has a nano or a micro scale.

Optionally, wherein the arrangement of individual elements is a periodic arrangement. For instance the periodic arrangement can be an array or can form a geometric lattice such as a square grid, or a hexagonal lattice and the like.

Optionally, the arrangement of individual elements supports resonant light matter interaction. For example the arrangement can create bound states in continuum or quasi-bound states in continuum. For example the individual elements can be arranged to obtain a plurality of resonances.

Optionally, the individual elements are holes formed within a layer of third order susceptibility material. For example the holes can be dimmer holes or dimmer-airy holes.

Optionally, the individual elements are nano or micro elements formed of a third-order susceptibility material. For instance the nano or micro elements can include various protruding three dimensional shapes such as disks or cylinders. The individual elements can also be nano particles or aggregates of particles.

Optionally, the individual elements are provided on a substrate. For example the substrate can be made of glass, silicon oxide, quartz, sapphire, or magnesium fluoride MgF. The substrate can be a thin layer or slab.

Optionally, the structure comprises several layers of individual elements.

Optionally, the nonlinear process is one of a four wave mixing process and a third harmonic emission process.

Optionally, the third-order susceptibility material comprises at least one of a dielectric material, a semiconductor material, an oxides based material, a transition metal dichalcogenide material, and a nitrides based material. For example the third-order susceptibility material can comprise silicon or germanium.

Optionally, the frequency conversion device has an active area equal or greater than about 20 μm×20 μm. For example the active area can be greater than 30 μm×30 μm, or greater than about 50 μm×50 μm or greater than about 100 μm×100 μm. The active area can be designed to cover the area of the detector.

Optionally, the individual elements within the arrangement have a same shape and a same size.

Optionally, the individual elements within the arrangement have different shape and sizes.

Optionally, the structure comprises multiple regions of individual elements.

Optionally, each individual element within a region has a same shape and a same size, wherein the shape and size of individual elements are different for each region.

Optionally, the individual elements within a region have different shape and sizes; wherein the shape and size of individual elements are different for each region.

According to a second aspect of the disclosure, there is provided an imaging system for imaging a sample, the system comprising a frequency conversion device according to the first aspect; an optical arrangement configured to collect the first beam of electromagnetic radiation having the first wavelength in the infrared region and to direct the first beam onto the frequency conversion device to generate the output beam of radiation at a wavelength of less than about 1000 nm; wherein the first beam of electromagnetic radiation passes through or arises from the sample; and a detector configured to detect the output beam of radiation to obtain an image of the sample.

For example the sample can be an object or a subject.

For example the frequency conversion device can be integrated with the detector. For instance the structure made of a third-order susceptibility material can be provided onto a surface of the detector.

Optionally, the imaging system comprises one or more radiation sources adapted to generate at least one of a first pump beam of electromagnetic radiation having a second wavelength and a second pump beam of electromagnetic radiation having a third wavelength.

Optionally, the frequency conversion device is configured to resonate at one or more of the first wavelength of the first beam, the second wavelength of the first pump beam, the third wavelength of the second pump beam, or the wavelength of the output beam.

Each one of the first wavelength, the second wavelength and the third wavelength can form a wavelength range extending over several wavelengths.

Optionally, the system forms a sensor adapted to sense visible, near infrared and/or mid infrared radiations.

According to a third aspect of the disclosure, there is provided a method of imaging a sample, the method comprises providing a frequency conversion device according to the first aspect comprising a structure made of a third-order susceptibility material adapted to convert a first beam of electromagnetic radiation having a first wavelength in the infrared region into an output beam having a wavelength of less than about 1000 nm via a nonlinear process; collecting the first beam of electromagnetic radiation; wherein the first beam of electromagnetic radiation passes through or arises from the sample; directing the first beam onto the frequency conversion device to generate the output beam of radiation; and detecting the output beam of radiation to obtain an image of the sample.

Optionally, the method comprises generating a first pump beam of electromagnetic radiation having a second wavelength; and mixing the first beam and the first pump beam using the frequency conversion device to obtain the output beam.

Optionally, the method comprises generating a second pump beam of electromagnetic radiation having a third wavelength; and mixing the first beam, the first pump beam and the second pump beam using the frequency conversion device to obtain the output beam.

Optionally, the method comprises varying at least one of the second wavelength and the third wavelength to adjust the wavelength and intensity of the output beam.

Optionally, at least one of the second wavelength of the first pump beam and the third wavelength of the second pump beam is greater than about 1000 nm.

Optionally, the third-order susceptibility material is configured to generate a nonlinear signal, wherein the nonlinear signal is one of a degenerate four wave mixing emission, a non-degenerate four wave mixing emission or a third harmonic emission.

According to a fourth aspect of the disclosure there is provided use of a frequency conversion device for imaging a sample; wherein the frequency conversion device comprises a structure made of a third-order susceptibility material adapted to convert a first beam of electromagnetic radiation having a first wavelength in the infrared region into an output beam having a wavelength of less than about 1000 nm via a nonlinear process.

The options described with respect to the first aspect of the disclosure are also common to the second, the third and the fourth aspects of the disclosure.

### BRIEF DESCRIPTION OF THE DRAWINGS

The disclosure is described in further detail below by way of example and with reference to the accompanying drawings.

FIG. 1 is a flow chart of a method for imaging a sample according to the disclosure.

FIG. 2A is a diagram of a system for implementing the method of FIG. 1.

FIG. 2B is an exemplary target sample for use in the system of FIG. 2A.

FIG. 3A is another diagram of a system for implementing the method of FIG. 1.

FIG. 3B is a diagram showing direct incidence of the first beam and the pump beam onto the frequency conversion device.

FIG. 4A is a diagram illustrating a first example of the four wave mixing process.

FIG. 4B is a diagram illustrating the different frequencies that can be generated with a degenerate FWM.

FIG. 4C is a diagram illustrating the different frequencies that can be generated with a non-degenerate FWM.

FIG. 5 is a diagram of an exemplary frequency conversion designed for third-order nonlinear frequency conversion.

FIG. 6A is a plot of the transmission spectra obtained with a frequency conversion device based on an array of nanopillars.

FIG. 6B is a cross sectional view of a nanopillar on a substrate.

FIGS. 7A-D is a set of FWM emissions obtained for different values of pump and signal frequencies.

FIG. 8A is an image of a target measured under white light illumination.

FIG. 8B is an image of the target measured using the set-up of FIG. 3 with a signal beam at 1600 nm and a pump beam at 1100 nm.

FIGS. 9A-9C is a set of images obtained for a same target and measured using the set-up of FIG. 3 with different combinations of signal and pump beams.

FIG. 10A is a plot of the transmission spectra obtained with a frequency conversion device based on another array of nanopillars.

FIG. 10B is a cross sectional view of a nanopillar on a substrate.

FIG. 11A-D is a set of FWM emissions obtained for different values of pump and signal frequencies.

FIG. 12A-12D show images of a same target measured using the set-up of FIG. 3 with different combination of signal and pump beams.

FIG. 13A is a plot of the transmission spectra obtained with a frequency conversion device based on an array of nano disks.

FIG. 13B is a cross sectional view of a nano disk on a substrate.

FIG. 14 is a table providing the simulated output wavelength λ_{FWM} obtained for various signal and input beams of the disk metasurface of FIG. 13.

FIG. 15 is a plot showing the simulated conversion efficiency obtained for the various scenarios presented in FIG. 14.

FIG. 16 is a simulation showing the electric filed enhancement obtained at different resonance frequencies.

FIG. 17 is a diagram of an exemplary frequency conversion device including an array of micro/nano elements on a substrate.

FIG. 18A is a plot of the transmission spectra obtained with a frequency conversion device based on an array of nano disks formed on a slab.

FIG. 18B is a cross sectional view of a nano disk and slab on a substrate.

FIG. 19 is a table providing the simulated output wavelength λ_{FWM} obtained for various signal and input beams of the metasurface of FIG. 18.

FIG. 20 is a plot showing the simulated conversion efficiency obtained for the various scenarios presented in FIG. 19.

FIG. 21 is a simulation showing the electric filed enhancement obtained at different resonance frequencies.

FIG. 22 is a diagram of another exemplary frequency conversion device based on an array of nano holes formed within a slab.

FIG. 23A is a plot of the transmission spectra obtained with a frequency conversion device with slab-hole configuration.

FIG. 23B is a cross sectional view of slab with nano hole provided on a substrate.

FIG. 24 is a table providing the simulated output wavelength λ_{FWM} obtained for various signal and input beams of the hole metasurface of FIG. 23.

FIG. 25 is a plot showing the simulated conversion efficiency obtained for the various scenarios presented in FIG. 24.

FIG. 26 is a simulation showing the electric filed enhancement obtained at different resonance frequencies.

FIG. 27A is a diagram of an exemplary polarisation-sensitive frequency conversion device for THG.

FIG. 27B is a partial top view of a metasurface showing two dimer-airy holes.

FIG. 28 is a plot showing THG spectra measured from metasurfaces designed with different offset xo.

FIG. 29 is a plot showing the calculated band structure for the metasurface when x₀=150 nm.

FIG. 30 is a simulation of the nearfield electric distributions for the mode TE(3,1,1) and TE(3,2,1), respectively.

FIG. 31 is a plot of the measured linear transmission spectrum of the metasurface under a white light source illumination.

FIG. 32A is a set of plots showing the measured transmission spectra of metasurfaces designed with different offsets.

FIG. 32B is a set of plots showing the angular dependence of the transmission spectrum by changing the incident angle θ, of the y-polarised pump light along xz plane.

FIG. 33 illustrates THG imaging using a metasurface.

FIG. 34A is a plot of the transmission spectra obtained experimentally with a frequency conversion device with a metasurface as described in FIG. 17.

FIG. 34B is a cross sectional view of a nano disk and slab on a substrate.

FIG. 34C is an electron microcopy image of the metasurface formed of the nano disks of FIG. 34B.

FIG. 35 is a set of FWM emissions obtained for different values of signal frequencies using the metasurface of FIG. 34C.

FIG. 36 is a set of FWM emissions obtained for different values of pump frequencies using the metasurface of FIG. 34C.

FIG. 37A is an image of a target measured under white light illumination.

FIG. 37B is an image of the target of FIG. 37A measured using the set-up of FIG. 3 with a signal beam at 2250 nm and a pump beam at 1130 nm.

FIGS. 38A-38H is a set of images obtained for the same target of FIG. 37A and measured using the set-up of FIG. 3 with different combinations of signal and pump beams.

FIG. 39A is an image of a ‘NTU’ target measured under white light illumination.

FIG. 39B is an image of the ‘NTU’ target measured using the set-up of FIG. 3 with a signal beam at 2200 nm and a pump beam at 1130 nm.

FIG. 40 is a schematic diagram of a structure having several regions or sub-metasurfaces.

### DETAILED DESCRIPTION OF THE DISCLOSURE

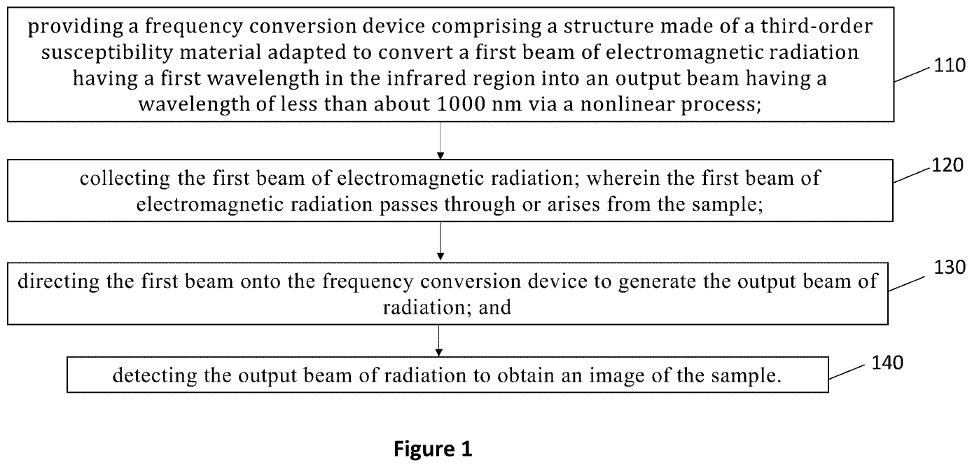

FIG. 1 is a flow chart of a method for imaging a sample according to the disclosure. The sample can take different forms, it can be an object or a subject.

At step 110 a frequency conversion device is provided. The frequency conversion device includes a structure made of a third-order susceptibility material adapted to convert a first beam of electromagnetic radiation having a first wavelength in the infrared region into an output beam having a wavelength of less than about 1000 nm via a nonlinear process.

For instance the first beam can be a beam in the short, near or mid infrared region. For instance the first wavelength can be greater than about 1000 nm, for instance between about 1000 nm to about 50000 nm.

The third-order susceptibility material can be configured to generate a degenerate four wave mixing emission, a non-degenerate four wave mixing emission or a third harmonic emission. For FWM, two pump beams at different wavelengths can be used, i.e. in total, three input frequencies and one output frequency, for each FWM process.

At step 120 the first beam of electromagnetic radiation is collected. The first beam of electromagnetic radiation passes through or arises from the sample. At step 130 the first beam is directed onto the frequency conversion device to generate the output beam of radiation at a wavelength of less than about 1000 nm. At step 140 the output beam is detected to obtain an image of the sample.

The output beam can have a wavelength between about 400 nm and 1000 nm.

Therefore the output beam can be detected using a conventional visible detector. Conventional visible detectors/cameras can detect radiation in the range of 400-1000 nm, which goes beyond the traditional visible spectrum (400-700 nm).

The first beam can be mixed on the frequency device with one or more pump beams having different frequencies/wavelengths to generate the output beam.

Therefore the method can further include the steps of generating one or more pump beam(s) of electromagnetic radiation. For instance generating a first pump beam having a second wavelength and a second pump beam having a third wavelength. Then the method can include mixing the first beam and the second or more pump beams using the frequency conversion device to obtain the output beam of electromagnetic radiation. The wavelength of the pump beam(s) can have a wavelength greater than about 1000 nm, to avoid generating noise in the detection band (400-1000 nm). For instance the one or more pump beams can be IR pump beams.

The structure made of the third-order susceptibility material can be adapted to be functional independently of the polarisation of the first wavelength in the infrared region.

It will be appreciated that if the subject is a living animal or individual, the power of the light beam(s) being used should be set to prevent harming the subject.

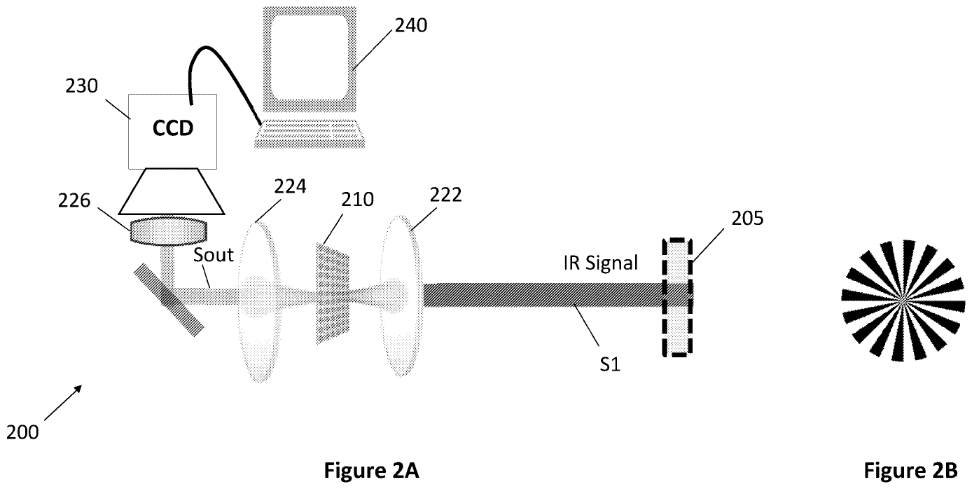

FIG. 2A is a diagram of a system for implementing the method of FIG. 1. FIG. 2A illustrates the case in which the frequency conversion device is used to perform third harmonic generation (THG). the first beam of IR electromagnetic radiation is the input, and the output beam having a wavelength less than about 1000 nm is generated through THG in the frequency conversion device. The system 200 can be also used for imaging though other odd-order harmonic generations, such as fifth harmonic generation, seventh harmonic generation, etc.

The system 200 includes a frequency conversion device 210, an optical arrangement formed of optical elements 222, 224, 226, and a detector/camera 230. In this example, a first beam of electromagnetic radiation S1 in the infrared IR transmits, scatters or reflects through a target sample 205.

FIG. 2B is an exemplary target sample for use in the system of FIG. 2A. In this example the target sample is a wheel having multiple arms. However the target could take another form and have an arbitrary pattern. A first lens 222 is used to direct the first beam S1 onto the frequency conversion device 210 to generate a beam of visible radiation Svis. Depending on the application the lens 222 can be used to focus or defocus the first beam S1. A second lens 224, and a third lens 226 are used to image the visible beam onto the detector 230. It will be appreciated that the optical pathway between 210 and 230 can be implemented in different ways. In some systems, the lens 224 or the lens 226 alone can suffice. The detector 230 can also be provided with its own lens. The detector 230 can be couped to a processing device such a computer 240 to collect and analyze the detector data. For instance the detector 230 can be a charge coupled device CCD.

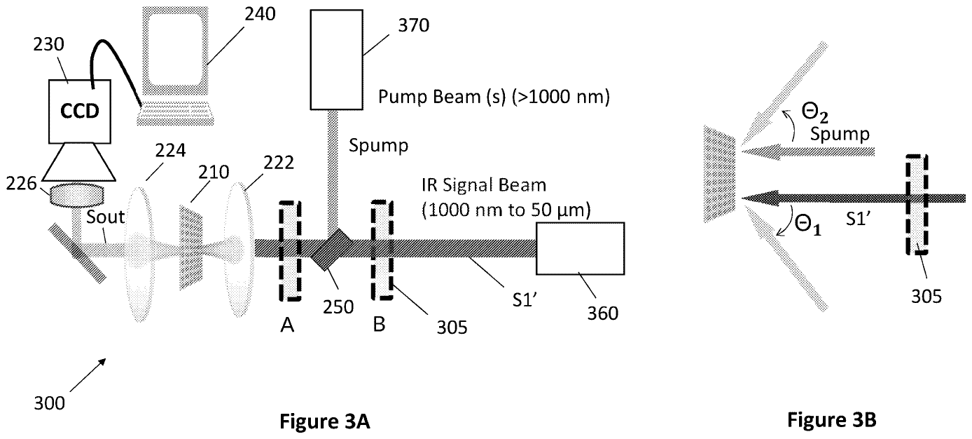

FIG. 3A is another diagram of a system for implementing the method of FIG. 1. FIG. 3A shows an experimental setup for imaging a target via one or more additional pump beams. Such pump beams can be used to perform for example four wave mixing (FWM), self-phase modulation (SPM), or cross-phase modulation (CPM).

The system 300 is similar to the system of FIG. 2. The same reference numerals have been used to represent corresponding components and their description will not be repeated for sake of brevity. In this case the target 205 has been replaced by a target 305, which can be located at point A or point B on the transmission axis of S1′.

A first source 360 is used to generate the IR signal S1′. For instance the IR signal S1′ can have a wavelength between about 1000 nm to about 50 μm. Additional radiation source(s) can be used to generate one or more pump beams Sₚᵤₘₚ₍ₛ₎ of electromagnetic radiation having additional wavelength(s).

A pump source 370 is used to generate a pump beam having a wavelength greater than about 1000 nm. The radiation sources can be selected from various technologies and do not need to be lasers, as there is no requirement for coherence.

The setup can be modified to include additional pump beams in order to perform higher order wave mixing process.

In this example, a beam splitter 250 is used to combine the first beam S1′ and the pump beam Sₚᵤₘₚ. The beams S1′ and Sₚᵤₘₚ are then mixed using the frequency conversion device 210 to obtain the output beam of electromagnetic radiation Sout. Alternatively, the pump beam(s) Sₚᵤₘₚ₍ₛ₎ can be directly directed to the surface of the frequency conversion device 210 through other incident angles. In such cases the beam splitter 250 is not needed.

FIG. 3B is a diagram showing direct incidence of the first beam and the pump beam onto the frequency conversion device 210. Both S1′ and Sₚᵤₘₚ can be illuminated on the metasurface with different angles represented as Θ1 and Θ2, even from the backside of the metasurface sample.

The frequency conversion device 210 provides an extension to the visible detector 230, enabling it to detect wavelength in the near-infrared, and mid-infrared regions. On some occasions, a filter can be used in front of the CCD/detector to filter the near-infrared signal and pass the output signal Sout.

The frequency conversion device 210 has a small footprint and can be implemented in different fashions. It is also relatively inexpensive to manufacture and can therefore save space, power consumption and cost of today's detectors such as the ones used in mobile phones, cars, and other applications.

The structure made of the third-order susceptibility material, for instance a metasurface, is very thin, in the order of 0.05 μm to 1 μm and can be fabricated on any surface. For instance the metasurface can be fabricated on a substrate or directly on the surface of the detectors or cameras being used. The substrate or surface on which the metasurface is provided does not need to be flat. In some applications the metasurface can also even be fabricated on thin membranes (~100 nm thickness) or it can be embedded in a thin flexible layer.

The metasurface can be designed to cover an area that is sufficient for the desired application and what the optical system is designed to image. Metasurfaces having an area smaller than about 20 μm×20μm can cause lattice perturbations at the array's edge breaking the coherence and leading to strong scattering of light into free space. To avoid such perturbations the active area of the frequency conversion device can be designed to be greater than about 20 μm×20μm, for instance a few 100 μm² or a few mm² or a few cm² or more.

The structure made of the third-order susceptibility material, for instance metasurface, can be located in an appropriate area of the optical system, to avoid perturbations at the edge of the structure.

Four-wave mixing (FWM) is a third-order nonlinear effect where two or three different incident photons are mixed together to generate a new photon at a different frequency.

If the input consists of only two different frequencies, a degenerate FWM takes place and four different frequencies can be generated based on the equation ω_{FWM}=20ω_{1,2}±ω_{2,1}.

For the three-photon case, i.e. using three different frequencies as the input (ω1, ω2 and ω3), a nondegenerate FWM process takes place, and four different frequencies can be generated at ω1+ω2+ω3, ω1+ω2−ω3, ω1+ω3−ω2, and ω2+ω3−ω1.

Third-harmonic generation (THG) is a sub-category of FWM, where all the input photons possess the same frequency.

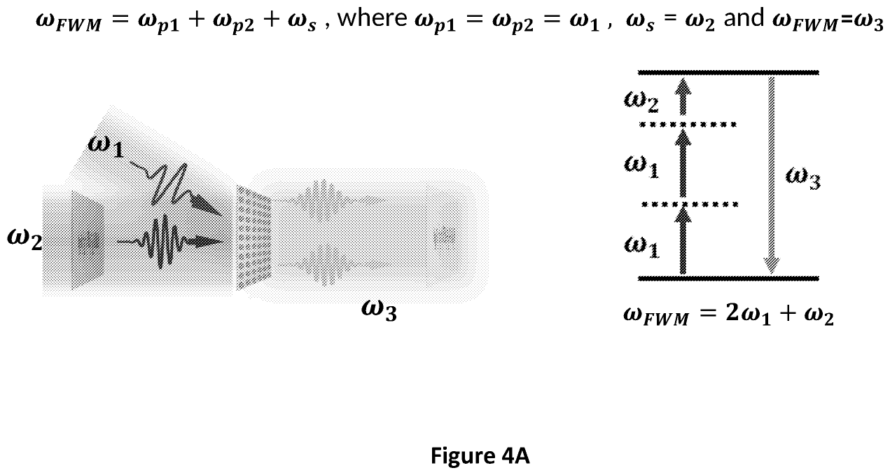

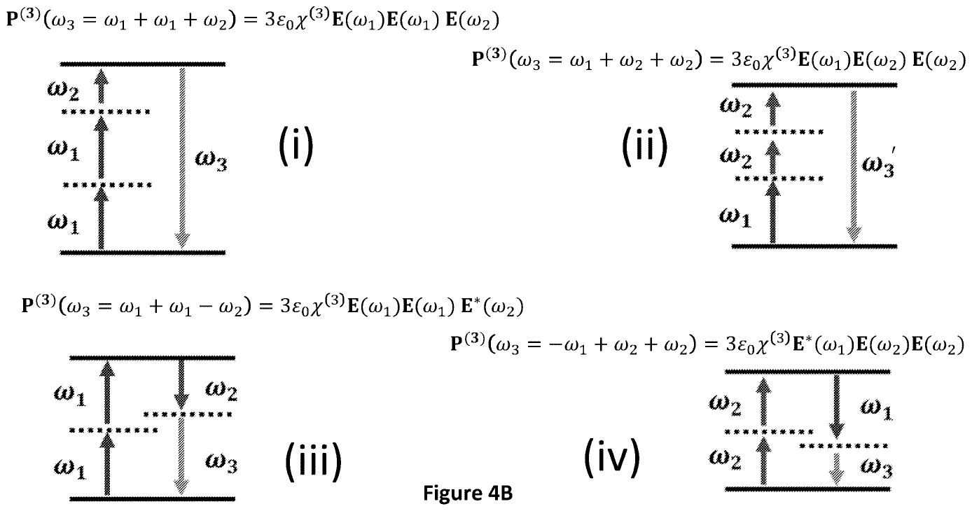

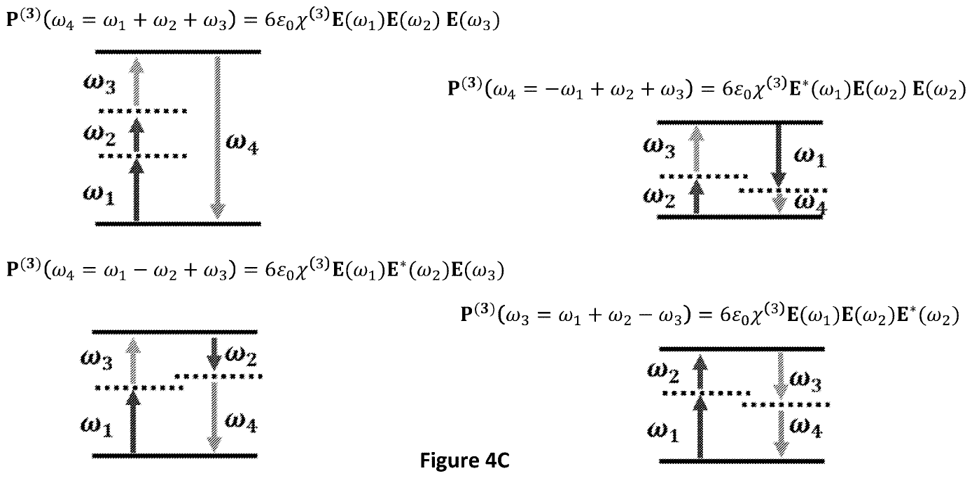

FIG. 4A is a diagram illustrating a first example of the four wave mixing process. The frequency of the output beam can be expressed as a function of the frequency of the signal beam ωₛ=ω₂ and the frequency of the pump beam ωₚ=ω₁ as ω_{FWM}=2 ω₁+ω₂. Therefore the frequency of the generated output beam can be adjusted by varying the frequency of the pump beam.

In photonics applications, the infrared spectral region can be divided into Near-Infrared (NIR) for wavelengths between 0.78-3 μm, Mid-Infrared (MIR) for wavelengths between 3-50 μm, and Far-Infrared (FIR) for wavelengths between 50-1000 μm (See ISO 20473 scheme).

Using the proposed approach an output beam (for instance a visible beam) can be generated by changing the wavelength of the pump beam regardless of whether the signal beam is in the NIR or the MIR region.

FIG. 4B is a diagram illustrating the different frequencies that can be generated with various FWM types, so-called degenerate FWM.

FIG. 4C is a diagram illustrating the different frequencies that can be generated with various FWM types, so-called non-degenerate FWM.

FWM can be generated by array of nanoparticles on substrate, array of nanoholes within a thin film on a substrate, array of nano-particles on a slab on a substrate, or any other nanoscale design, which resonate with the one or more frequencies involved in the FWM process.

The dimensions of the elements and the spacing between them can be chosen to achieve nonlinear imaging. These parameters can also be adjusted to achieve multiple resonances. Various resonant modes, generated by metasurfaces, can facilitate trapping light and enhancing the nonlinear processes. For instance the resonances can be chosen at the pump and signal wavelengths.

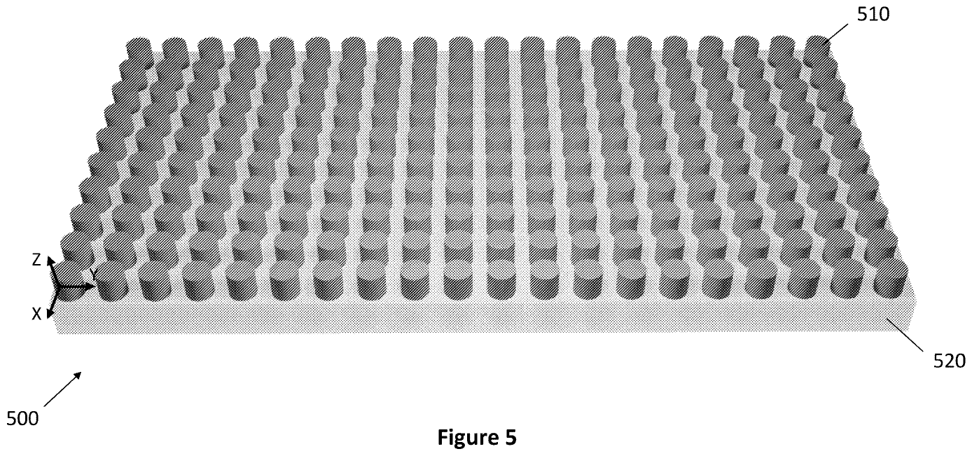

FIG. 5 is a diagram of an exemplary frequency conversion device 500 including an array of micro/nano elements 510 on a substrate 520, configured for third-order nonlinear frequency conversion. The substrate 520 can be a transparent substrate. The substrate can be selected depending on the application so that the substrate is transparent to the wavelength or range of wavelengths of the output beam. Example of substrates include glass, silicon oxide, quartz, sapphire, or magnesium fluoride MgF among others. For instance the nano elements can be nanoparticles such as silicon nanoparticles or nano islands which can include various protruding three dimensional shapes such as nano disks or nano cylinders. Based on the material, dimension, and arrangement of micro/nano elements, such a configuration can exhibit multipolar resonances (including electric dipole, magnetic dipole, and other higher-order electric and magnetic multipoles). The frequency conversion device 500 can be used in the systems of FIGS. 2 and 3.

The nano elements 510 are arranged to form an array which can be referred to as a metasurface. Metasurfaces are planar arrays of densely packed nanoantennas designed to manipulate the properties of incident light, including its amplitude, directionality, phase, polarization, and frequency. Since the nano elements 510 are nanopillars, the metasurface S1 is referred to as pillar metasurface. The metasurface S1 can be fabricated by regular electron beam lithography technique.

The frequency conversion device 500 can be used in various optical configurations, that is with the substrate 520 towards the IR beam or with the metasurface/nanoelements 510 towards the IR beam.

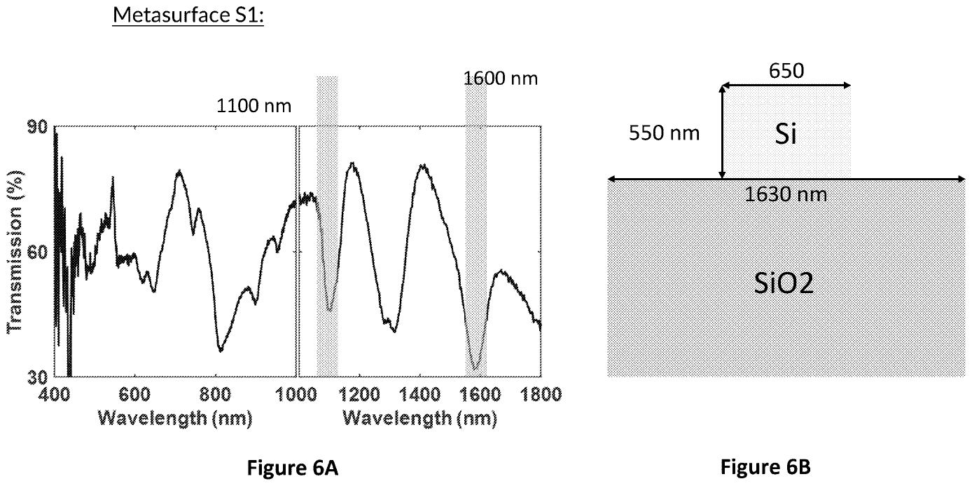

FIG. 6A is a plot of the transmission spectra obtained with a frequency conversion device based on an array of nanopillars. FIG. 6B is a cross sectional view of a nanopillar on a substrate.

In this example the frequency conversion device was fabricated out of commercial silicon on sapphire SoS substrate with silicon nanopillars—having a height of about 550 nm. The diameter and centre-to-centre separation of the nanopillars in this sample are 650 nm and 1630 nm, respectively. The frequency conversion device exhibits several Mie-type resonances, making it suitable for third-order nonlinear imaging. In this particular case, the device is designed to be resonant at 1600 nm and 1100 nm, which are the frequencies of frequency ω₁ and frequency ω₂ in FIG. 4B (i) and (ii), respectively.

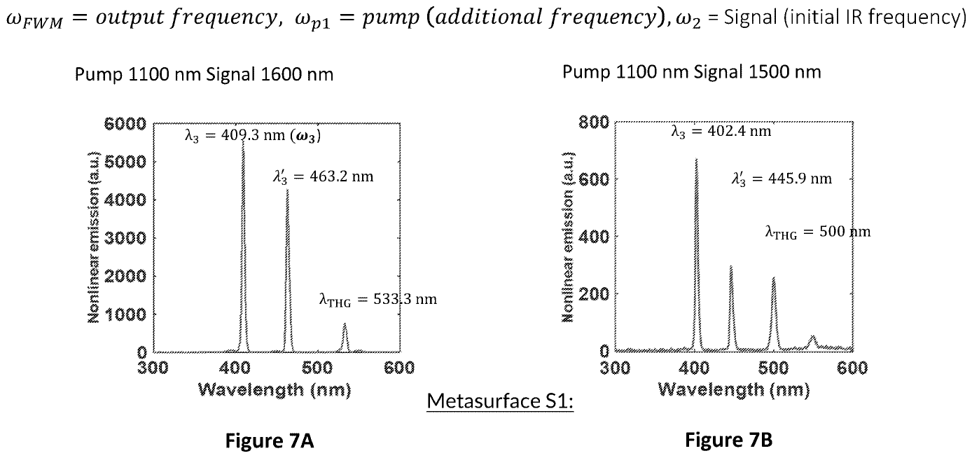

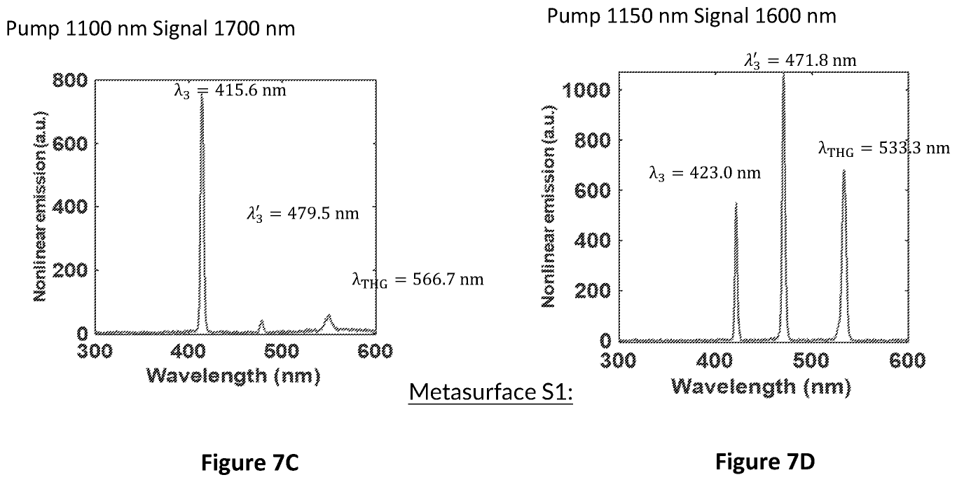

FIG. 7A-D shows FWM emissions obtained for different values of pump and signal frequencies. The FWM emission for third-order nonlinear imaging has a frequency ω₃ or ω₃′ that can be generated using a pump beam of frequency ω₁ and signal beam of frequency ω₂ via type (i) and type (ii) FWM processes (shown in FIG. 4B). By changing the pump frequency ω₁, one can control the wavelength of the FWM signal (ω₃ and/or ω₃′) emission. Also, multiple FWM emissions can be obtained. Some of the FWM processes are quadratically dependent on the pump intensity. One can boost the emission to a much higher level by controlling the pump power.

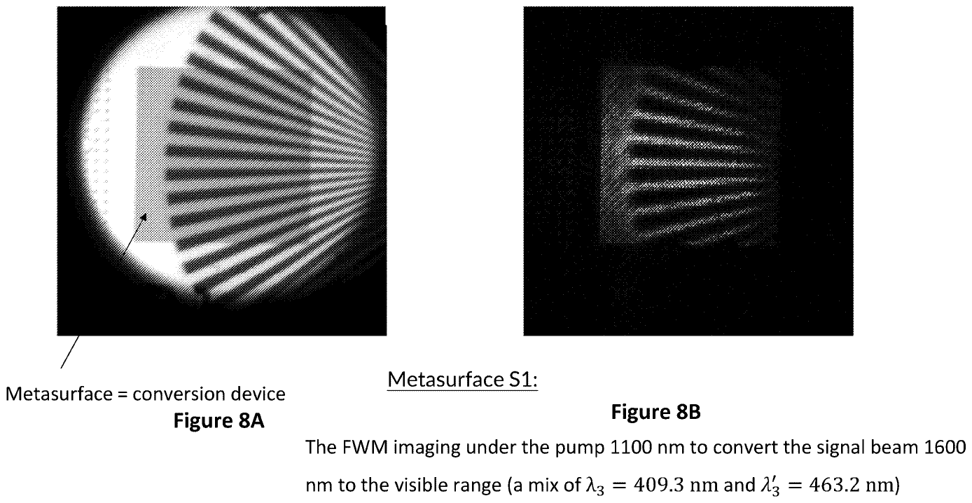

FIG. 8A shows an image of a target measured under white light illumination. The image is obtained using the setup of FIG. 3 but with a single white light source and no signal or pump beams. The detector 230 measures visible light passing through the target and through the frequency conversion device 210.

FIG. 8B shows an image of the same target measured using the set-up of FIG. 3 with a signal beam at 1600 nm and a pump beam at 1100 nm. The visible image of the target arises from visible light generated by the frequency conversion device 210 via FWM process as shown in FIG. 7A.

To demonstrate the effect of the FWM process alone for imaging, the THG frequency has been filtered out.

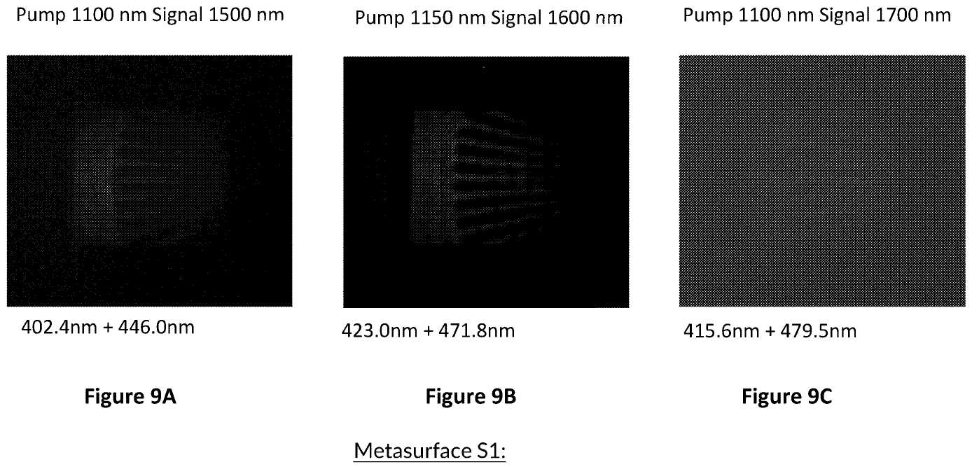

FIG. 9A shows an image of the same target measured using the set-up of FIG. 3 with a signal beam at 1500 nm and a pump beam at 1100 nm. FIG. 9B shows an image of the same target measured using the set-up of FIG. 3 with a signal beam at 1700 nm and a pump beam at 1100 nm. FIG. 9C shows an image of the same target measured using the set-up of FIG. 3 with a signal beam at 1600 nm and a pump beam at 1150 nm. The images of FIG. 9 demonstrate the importance of the designed metasurface and chosen frequency involved in the quality of the output image. To demonstrate the effect of FWM process alone, for imaging the THG frequency was filtered out.

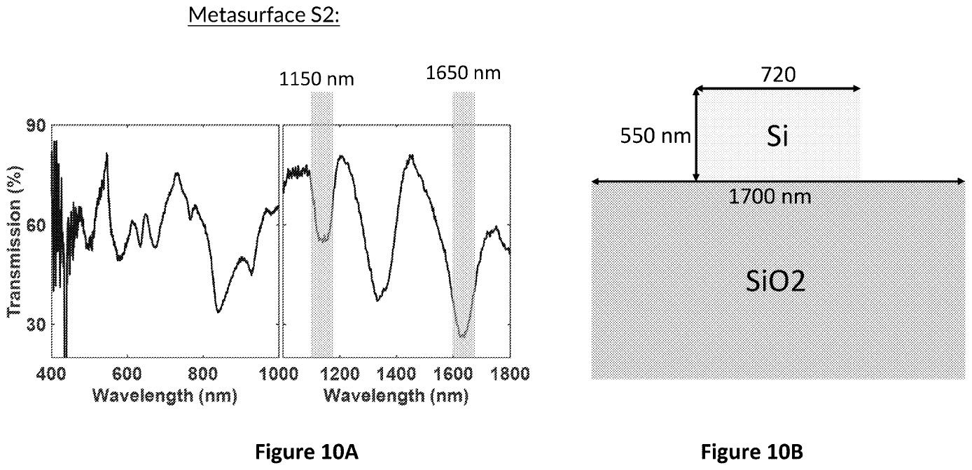

FIG. 10A is a plot of the transmission spectra obtained with a frequency conversion device based on another array of nanopillars (metasurface S2). FIG. 10B is a cross sectional view of a nanopillar on a substrate. The metasurface S2 can be fabricated by regular electron beam lithography technique.

The substrate and the height are similar to Metasurface 1. However, in this case the diameter and centre-to-centre separation of the nanopillars are 720 and 1700 nm, respectively. The Metasurface 2 exhibits several Mie-resonances (magnetic quadrupole, electric quadrupole, magnetic dipole, electric dipole), making it suitable for third-order nonlinear imaging. In this particular case, this device is designed to be resonant at 1150 nm and 1650 nm, which are the frequencies of frequency ω₁ and frequency ω₂ in FIG. 4B (i) and (ii).

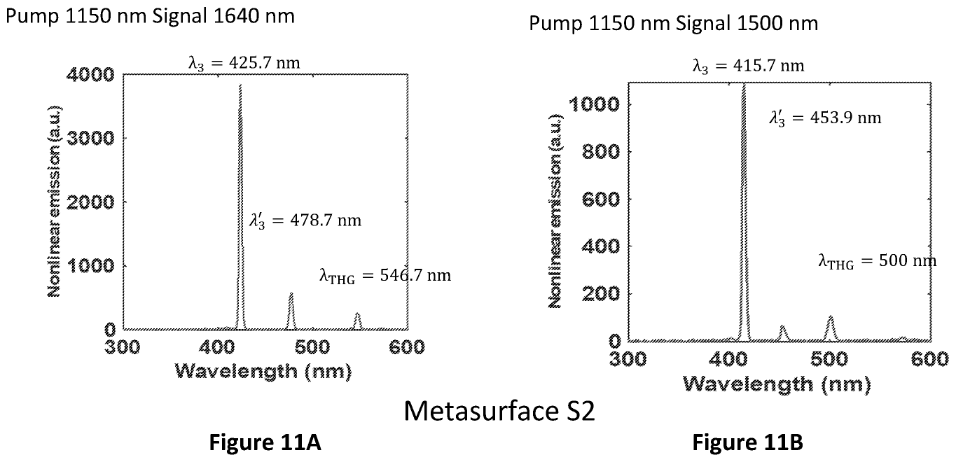

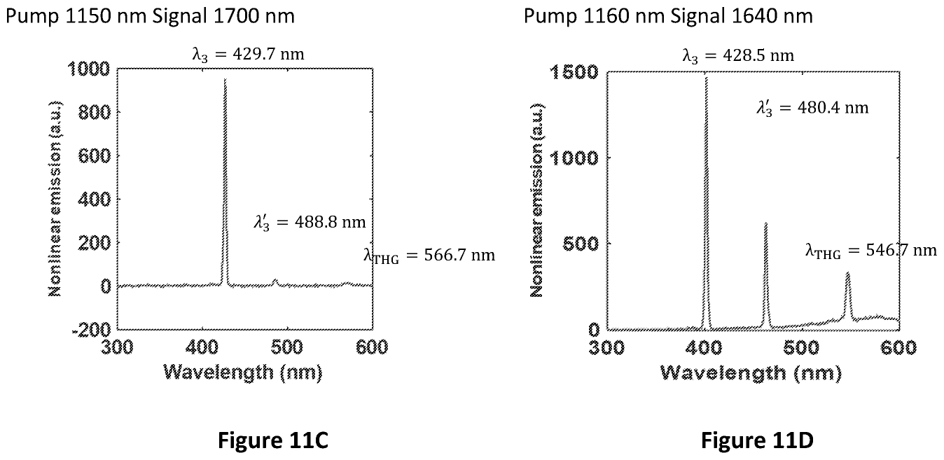

FIG. 11A-D show FWM emissions obtained for different values of pump and signal frequencies.

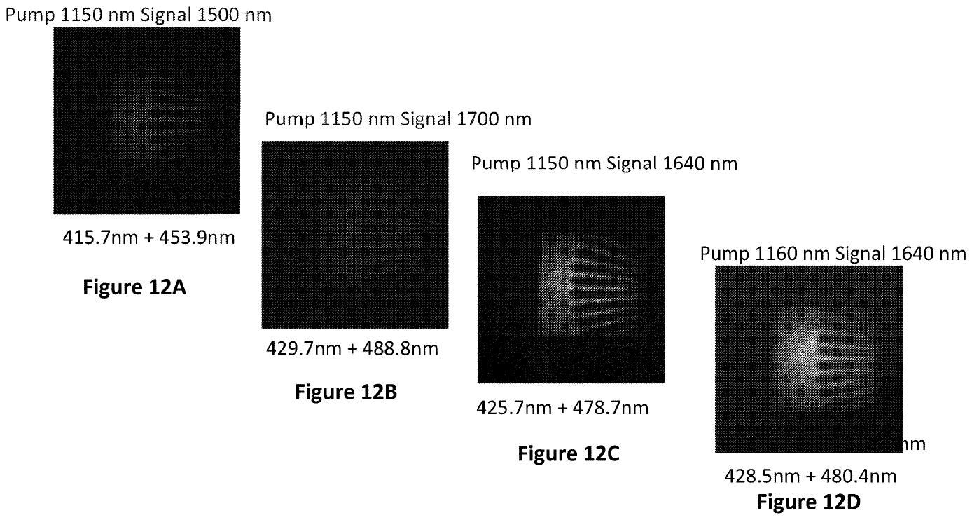

FIG. 12A-12D show images of a same target measured using the set-up of FIG. 3 with different combination of signal and pump beams. The images of FIG. 12 demonstrate the importance of the designed metasurface and chosen frequency involved in the quality of the output image.

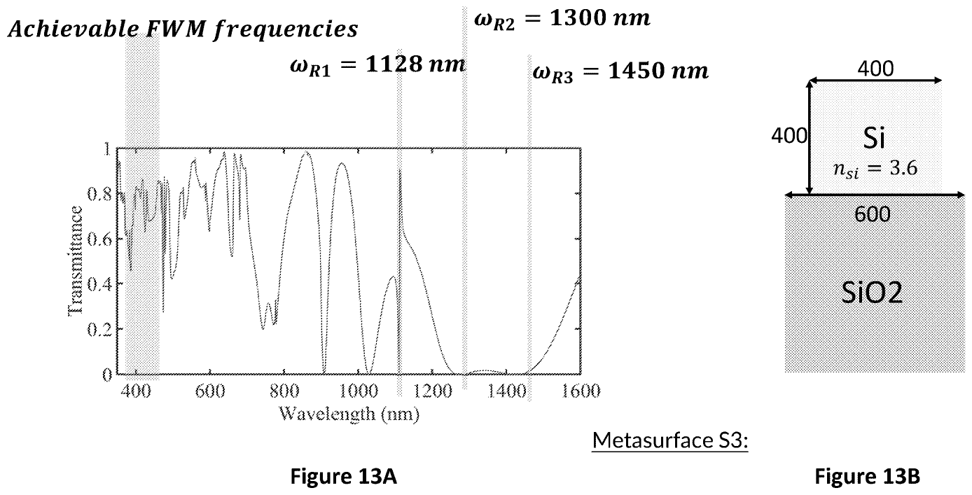

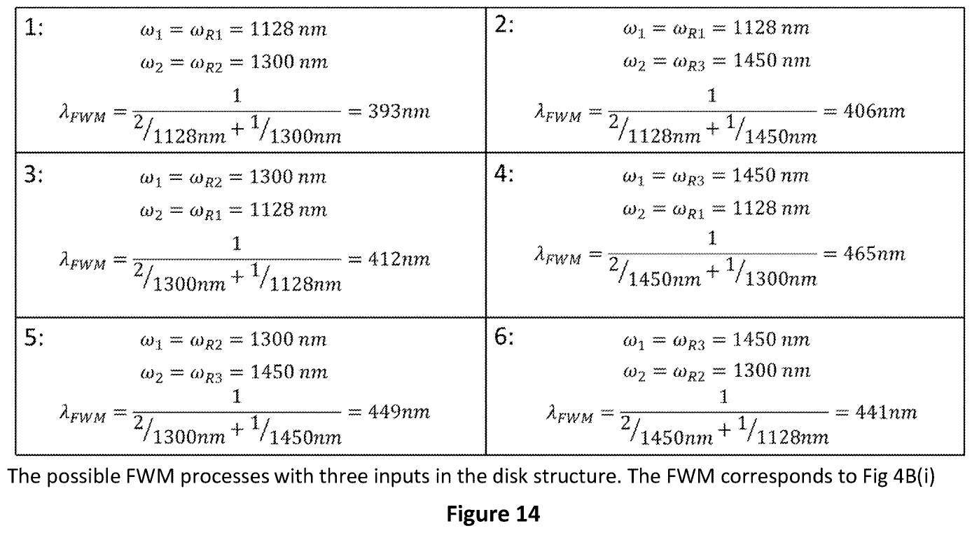

FIG. 13A is a simulation of the transmission spectra obtained with a frequency conversion device based on an array of nano disks. FIG. 13B is a cross sectional view of a nano disk on a substrate. In this case the height and diameter of the nanopillars are 400 nm and 400 nm, respectively. The separation (centre to centre) between nanopillars is 600 nm. This third Metasurface S3 also referred to as disk metasurface is configured to generate a combination of broad and sharp resonances. A high-Q (sharp) resonance is excited at ω_{R1}=1128 nm (Fano resonance) and two broad resonances (electric and magnetic dipole resonances) ω_{R2} and ω_{R3} are excited by the first electromagnetic frequency.

FIG. 14 is a table providing the simulated output wavelength λ_{FWM} obtained for various signal and input beams combinations of the disk metasurface S3 of FIG. 13. The FWM process corresponds to FIG. 4B(i). The output wavelength/frequency can be tuned, even though the first (incident) frequency is still at the resonance positions of the imaging device.

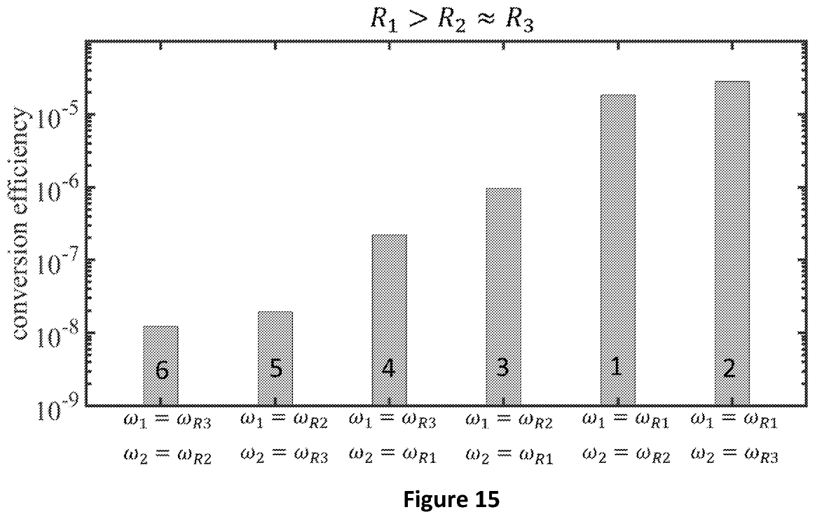

FIG. 15 is a plot showing the simulated conversion efficiency obtained for the various scenarios 1-6 presented in FIG. 14. The conversion efficiency is the highest when the pump frequency ω₁=ω_{R1} see cases 1 and 2. The nonlinear intensity is quadratically dependent on the pump intensity. When the pump is enhanced by the strong resonance, the conversion efficiency can be enhanced quadratically. The conversion efficiency is medium when the signal frequency ω₂=ω_{R1}, see cases 3 and 4 (different FWM process compared with 1 and 2). The nonlinear intensity is linearly dependent on the pump intensity. When the pump is enhanced by the strong resonance, the conversion efficiency can be enhanced linearly. The conversion efficiency is the lowest when there is no pump resonance involved in, see cases 6 and 5.

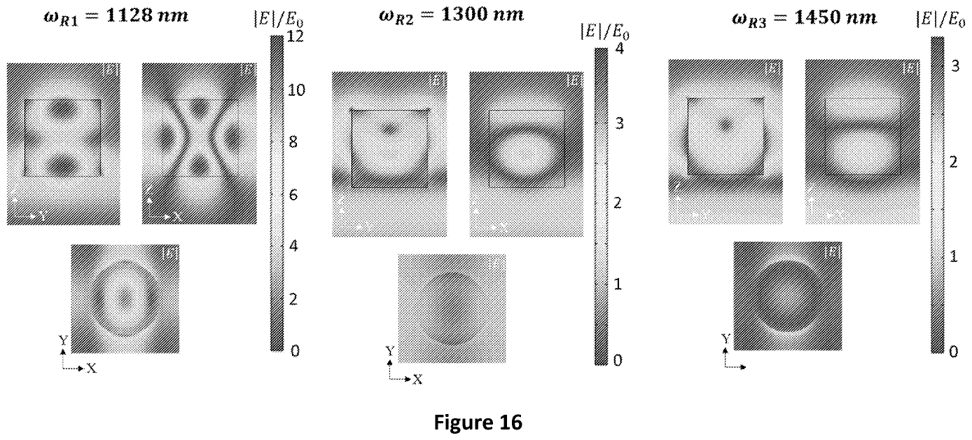

FIG. 16 is a simulation showing the electric filed enhancement obtained at different resonance frequencies. The simulation illustrates where the field is enhanced by pumping the light at the resonances. This explains the various conversion efficiency obtained in FIG. 15.

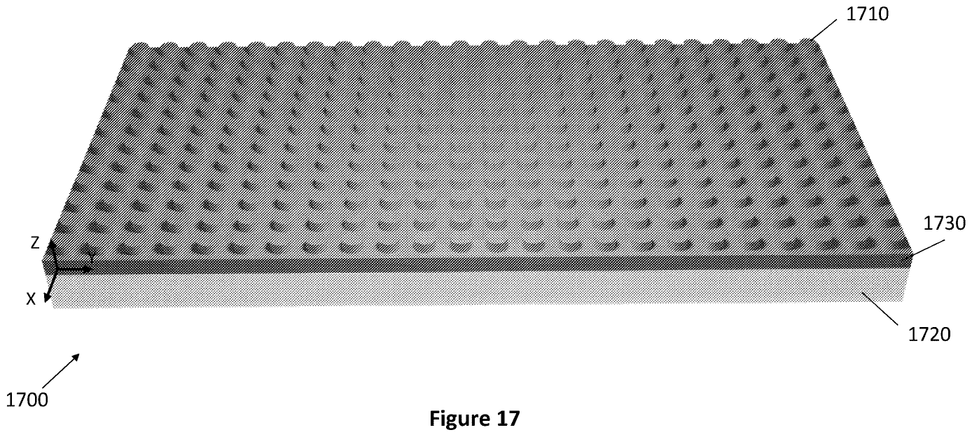

FIG. 17 is a diagram of an exemplary frequency conversion 1700 device including an array of micro/nano elements 1710 on a substrate 1720, configured for third-order nonlinear frequency conversion. Compared with the example of FIG. 5, the micro/nano elements are provided on the slab 1730 of third order susceptibility material. This configuration can be referred to as slab-disk configuration. The slab 1730 with the array of nano elements 1710 forms a metasurface. The slab of third order susceptibility material 1730 is provided on the substrate 1720. The frequency conversion device 1700 can be used to generate resonances, beyond pure Mie resonances.

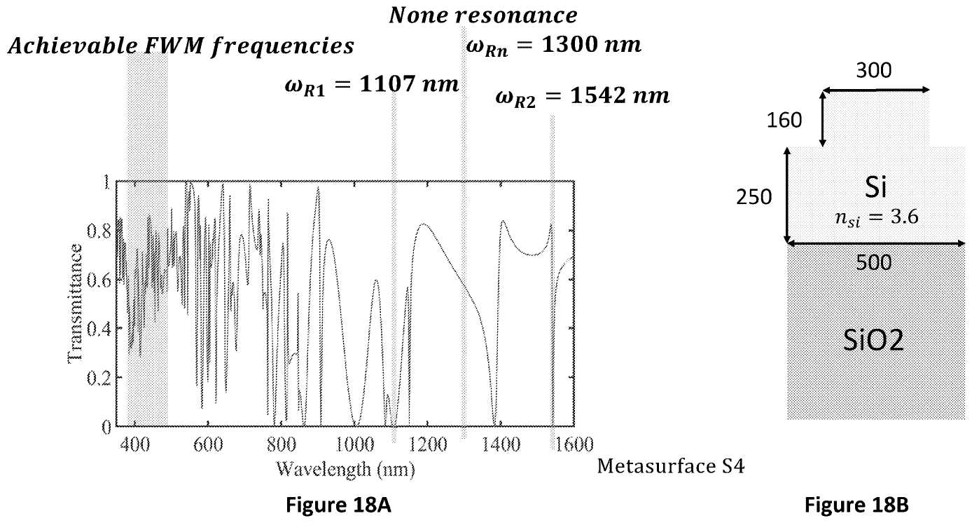

FIG. 18A is a simulation of the transmission spectra obtained with a frequency conversion device based on an array of nano disks formed on a slab. FIG. 18B is cross sectional view of a nano disk on a slab provided on a substrate. In this case the slab and nano disks are made of Silicon. The slab has a height of 250 nm. The nano disks have a height of 160 nm and a diameter of 300 nm. The separation centre to centre between nano disks is 500 nm. The substrate is made of silicon dioxide. This Metasurface S4 is configured to generate very sharp resonances (so-called high-Q) including guided resonances, Mie resonances, and bound states in the continuum, which enhance the device efficiency.

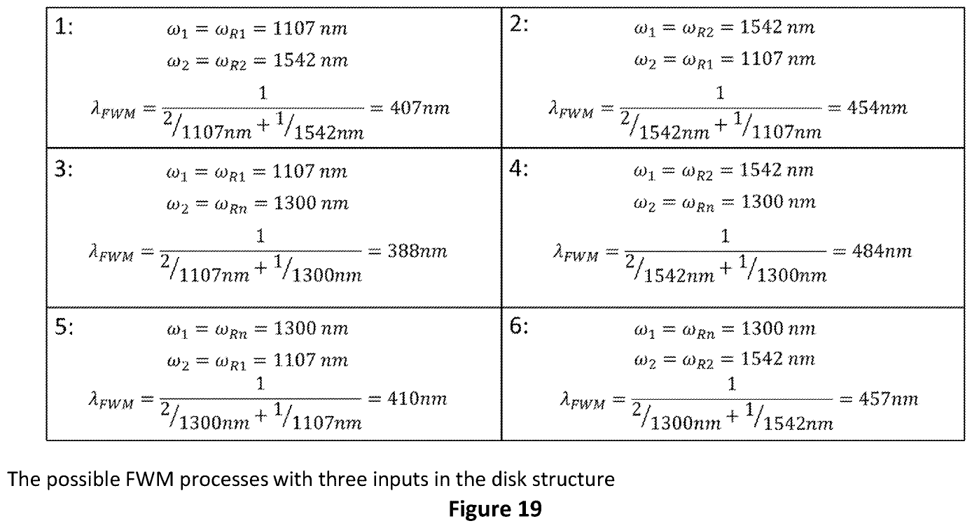

FIG. 19 is a table providing the simulated output wavelength λ_{FWM} obtained for various signal and input beams of the metasurface S4 of FIG. 18. The FWM process corresponds to FIG. 4B(i). The first (incident) frequency can be converted to various output frequencies.

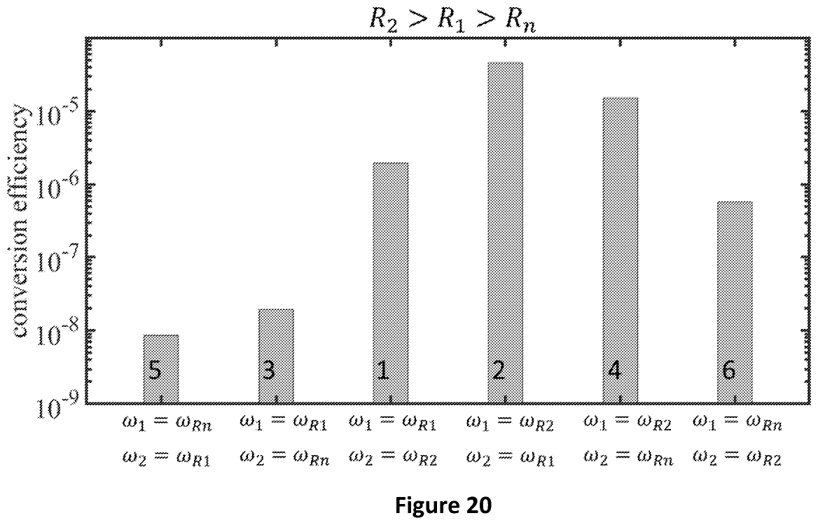

FIG. 20 is a plot showing the simulated conversion efficiency obtained for the various scenarios 1-6 presented in FIG. 19. With more resonances involved, the conversion efficiency increases. With less resonances involved; the conversion efficiency decreases. When the signal resonance is stronger than pump resonance, the process with signal resonance involved has a higher efficiency.

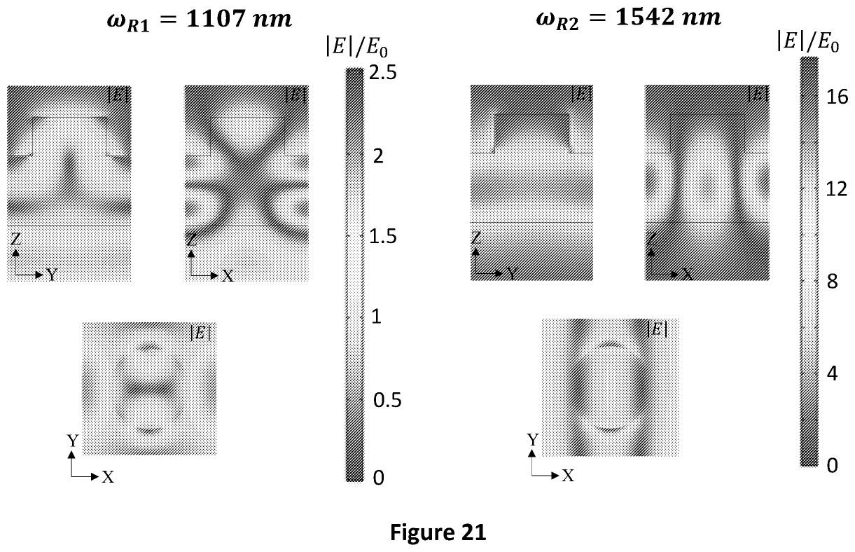

FIG. 21 is a simulation showing the electric filed enhancement obtained at different resonance frequencies. The near field is enhanced by pumping the light at the resonances with high-Q factors.

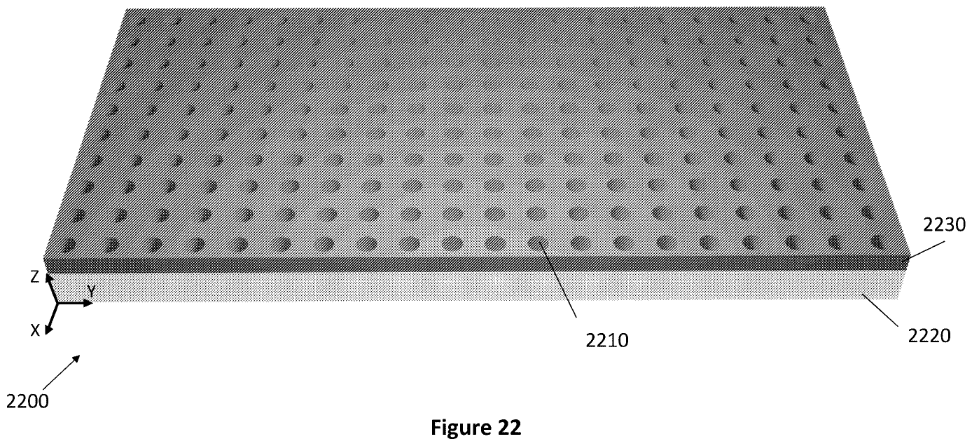

FIG. 22 is a diagram of another exemplary frequency conversion device 2200 configured for third-order nonlinear frequency conversion. The device 2200 includes an array of nano holes 2210 formed within a slab 2230 provided on a substrate 2220. This configuration can be referred to as slab-hole configuration. The slab 2230 with the array of nano holes 2210 forms a metasurface also referred to as hole metasurface. The slab 2230 is made of a third order susceptibility material, for instance Silicon. The frequency conversion device 2200 can be used to generate resonances, beyond pure Mie resonances.

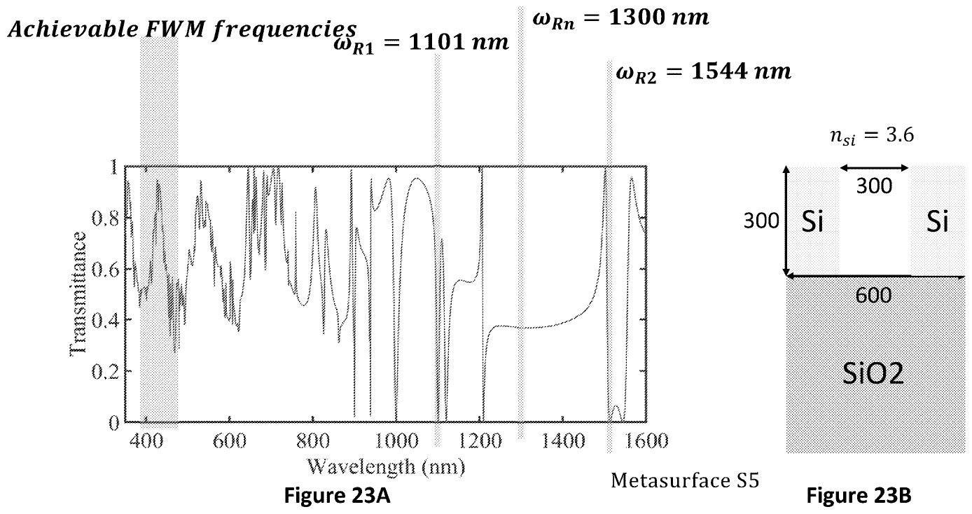

FIG. 23A is a simulation of the transmission spectra obtained with a frequency conversion device based on an array of nano holes formed on a slab referred to as slab-hole configuration. FIG. 23B is a cross sectional view of slab with nano hole provided on a substrate. In this case the slab and nano holes are made of Silicon. The slab has a height of 300 nm. The nano holes have a height of 300 nm and a diameter of 300 nm. The separation between nanoholes is 600 nm. The substrate is made of silicon dioxide. This Metasurface S5 is configured to generate very sharp resonances including guided resonances, Mie resonances, and bound states in the continuum, which enhance the device efficiency.

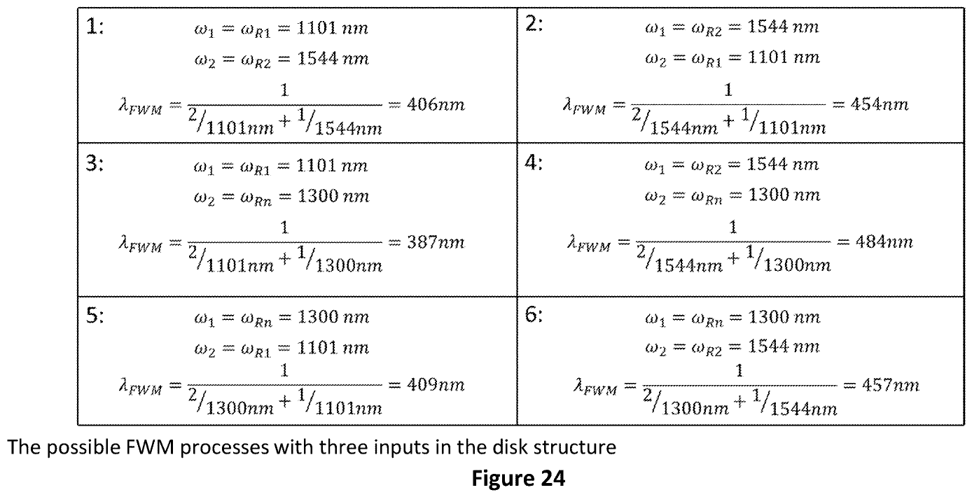

FIG. 24 is a table providing the simulated output wavelength λ_{FWM} obtained for various signal and input beams of the hole metasurface S5 of FIG. 23. The FWM process corresponds to FIG. 4B(i). The first (incident) frequency can be converted to various output frequencies.

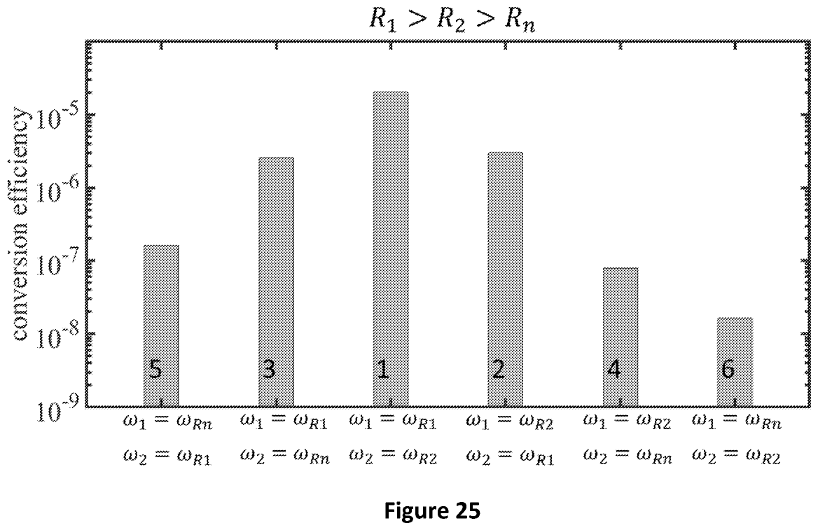

FIG. 25 is a plot showing the simulated conversion efficiency obtained for the various scenarios 1-6 presented in FIG. 24. When the pump resonance ω₁ is stronger than signal resonance ω₂, the process has a higher efficiency. The efficiency of case 1 is greater than the efficiency of case 2 because the resonance at ω_{R1} is greater than the resonance at ω_{R2}. Similarly the efficiency of case 4 is greater than the efficiency of case 6 because the resonance at ω_{R2} is greater than the resonance at ω_{Rn}.

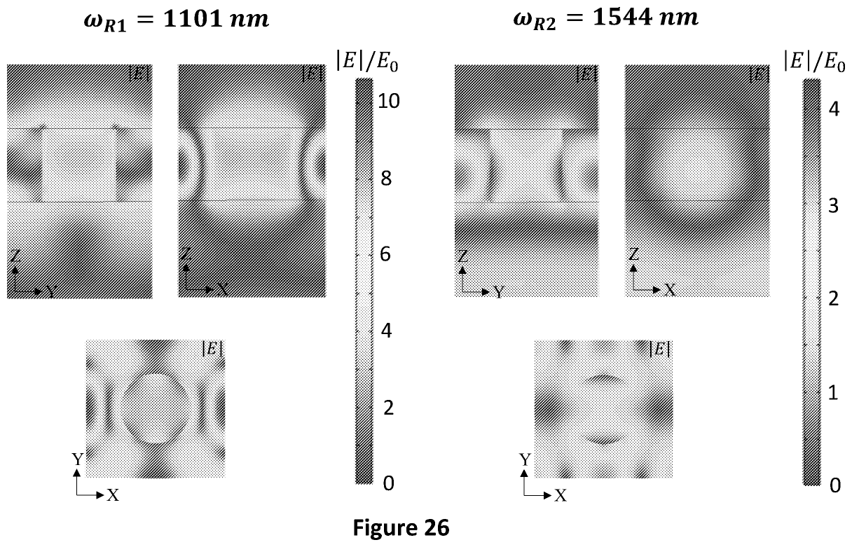

FIG. 26 is a simulation showing the electric filed enhancement obtained at different resonance frequencies. The near field is enhanced by pumping the light at the resonances with high-Q factors.

The implementations of the frequency conversion devices described above with respect to FIG. 5 onwards are some examples that can be reconfigured and redesigned for various applications. For example, these devices are polarisation-insensitive but could be designed for polarisation-sensitive applications.

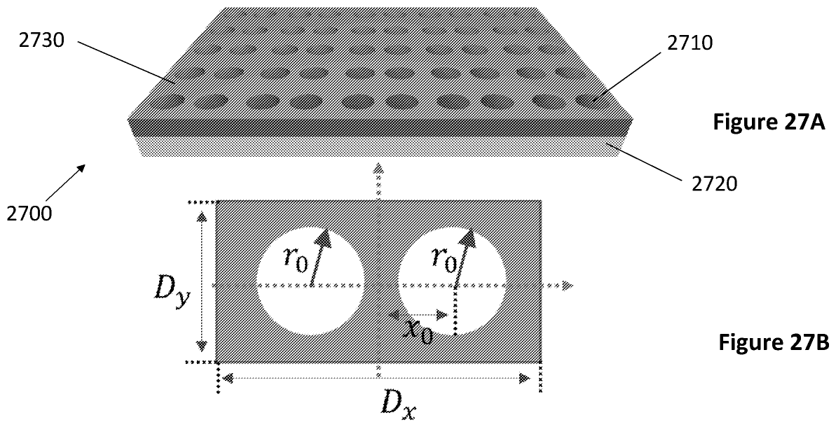

FIG. 27A is a diagram of an exemplary polarisation-sensitive frequency conversion device for THG. The frequency conversion device 2700 is similar to frequency conversion device 2200 of FIG. 22. The device 2700 includes an array of nano holes 2710 formed within a slab 2730 provided on a substrate 2720. The slab 2730 is made of a third-order susceptibility material for generating third-order nonlinear interactions, e.g. THG and FWM. For instance the third-order susceptibility material can comprise Silicon or Germanium. The substrate can be a glass or Sapphire substrate.

The slab comprises a periodic array of nanohole dimers (also referred to as dimer-airy holes) whose dimensions and periods are small compared with the wavelength of an incoming radiation. This structure can be referred to as a hole metasurface or membrane metasurface. Like in the previous examples the dimensions of the nanohole elements in this configuration and the spacing between them are chosen to achieve nonlinear imaging via FWM interaction.

FIG. 27B is a partial top view of the metasurface 2730 showing two dimer-airy holes. The radius r₀ of each hole is shown with an arrow labelled and the offset between the two holes is given by the parameter x₀. The offset parameter xo is defined as the distance from the centre of one airy hole to the centre of the dimer hole. By changing the value of the offset (either increasing or decreasing) the dimensions of the periodic slice in the x and y direction (Dₓ and D_{y}) are shortened or lengthened. The value of the offset will affect the resonances that can be achieved within the material and hence the frequencies the conversion device will be able to convert in order to obtain a visible image.

The hole metasurface 2730 is designed to support multiple symmetry-protected bound states in the continuum (BICs). The strong light confinement within the metasurfaces is an important factor in achieving strong light-matter interactions and generating nonlinear signals with higher intensity under relatively low-power input light. The bound states in the continuum (BICs) can be used to manipulate the light-matter interactions (C. W. Hsu, et al, Nature Reviews Materials, 2016, 1, 1-13.).

Compared with dielectric metasurfaces composed of an array of nanoparticles, metasurfaces based on nonlinear material with an array of holes can obtain a larger mode volume for enhancing light matter interaction (L. Xu, et Al, New Journal of Physics, 2022, 24, 035002). By tuning the gap between two airy holes, the symmetry-protected BICs can be transformed into the quasi-BICs with high Q-factor, resulting in a strong electromagnetic field confinement within the silicon membrane via plane-wave illumination. Compared with disk metasurfaces, the hole metasurfaces provide more options for designing the light-matter interactions due to their unique optical response.

In a specific example the amorphous silicon (a-Si) membrane metasurface is formed of a 235-nm-thick silicon slab with dimer airy holes arranged periodically on a glass substrate. The radius of the airy hole is fixed as r₀=100 nm. The period along x and y directions Dₓ and D_{y} are set to be 600 nm and 300 nm, respectively. Thus when the offset x₀=150 nm, the dimer-hole membrane metasurface is the same as a hole membrane metasurface with the unit cell period Dₓ=D_{y}=300 nm. The system of the a-Si membrane metasurface is invariant under the 180 degree rotation around the z-axis. which is defined as the operation

$${C}_{2}^{Z} .$$

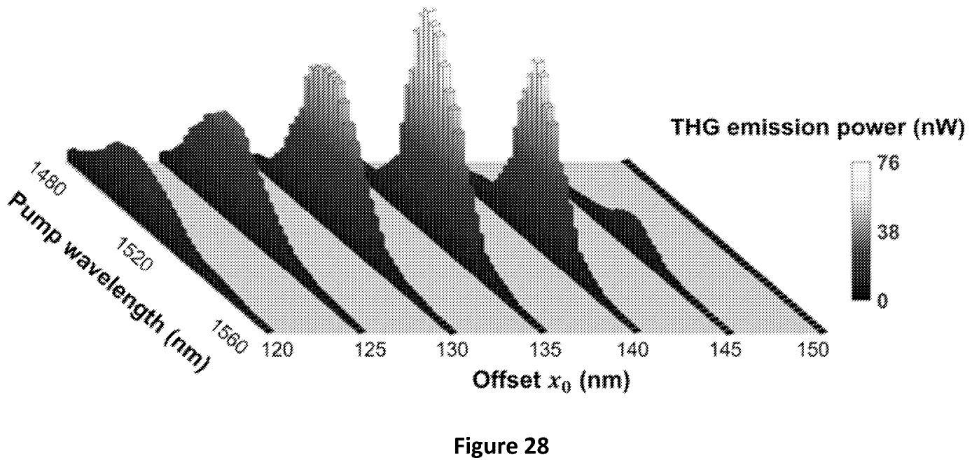

The characteristics of this membrane metasurface are described in FIGS. 28 to 32.

FIG. 28 is a plot showing THG spectra measured from metasurfaces designed with different offset x₀. The TH emissions are dramatically enhanced at the resonance spectral position. With the offset increase from 120 nm to 150 nm, the measured TH emission first increase to a maximum value when the offset is 135 nm, and then gradually decrease.

The width of resonance is experimentally estimated as 20 nm for x₀=135 nm. This matches well with the width of the pump laser around 1500 nm, suggesting the best coupling scheme for obtaining large nonlinear emission power. When the offset is 150 nm, no significant enhancement of the TH emission is observed. This observation agrees with the fact that the ideal BIC is formed and the coupling of the BIC with external radiation has been suppressed when x₀=150 nm. The THG conversion efficiency is estimated as the collected THG power divided by the incident pump power: η_{THG}=P_{THG}/Pₚᵤₘₚ. A maximum THG conversion efficiency is obtained around 3.6×10⁻⁶ experimentally when the offset x₀=135 nm.

The mode properties of the membrane metasurface are characterized by calculating the band structure based on the Massachusetts Institute of Technology Photonic-Bands (MPB) open sources.

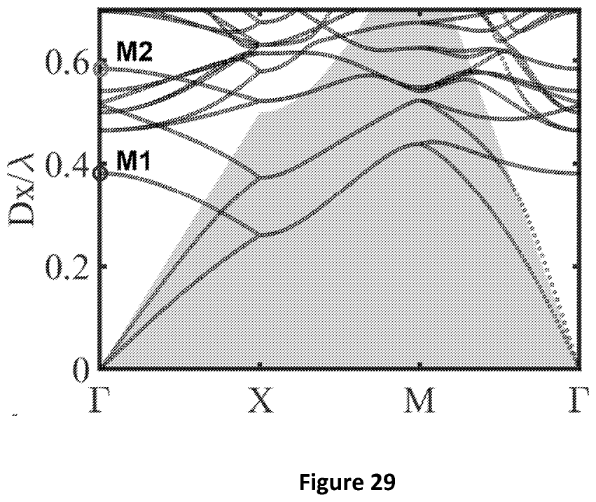

FIG. 29 shows the calculated band structure for the metasurface when x₀=150 nm.

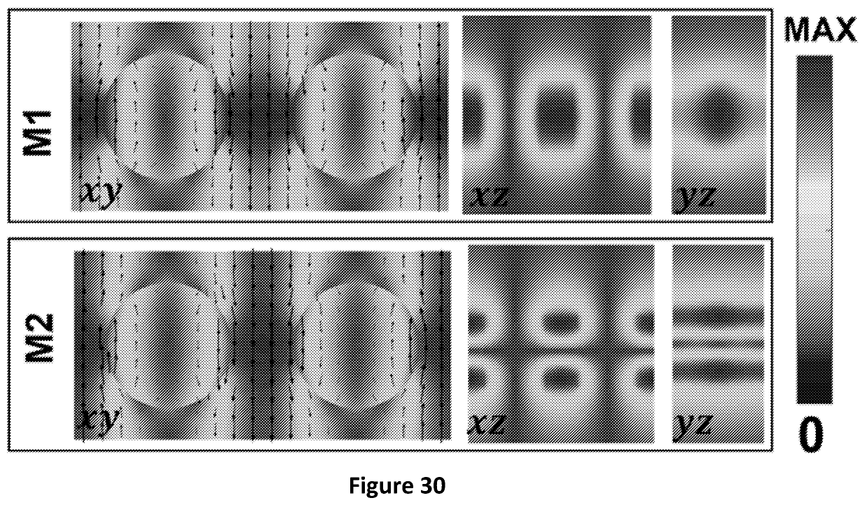

FIG. 30 shows the nearfield electric distributions for the mode TE(3,1,1) and TE(3,2,1), respectively. For the considered unit cell with pitch sizes of Dₓ=600 nm and D_{y}=300 nm, two typical odd modes are observed under

$${C}_{2}^{Z} ,$$

TE(3,1,1) and TE(3,2,1) with their electric pattern M1 and M2 (see FIG. 10B)). However, when x₀=150 nm, the pitch sizes (Dₓ×D_{y}) of unit cell changes from 600×300 nm to 300×300 nm. With the transformation of the unit cell, the two modes, TE(3,1,1) and TE(3,2,1), become even under

$${C}_{2}^{Z} ,$$

decoupling to the odd leaky channel to the far-field. The features of TE(3,1,1) and TE(3,2,1) indicate that they are symmetry protected BICs with infinite Q-factor when x₀=150 nm, and can be converted into quasi-BICs with finite Q-factor when the offset x₀ is tuned.

By controlling the offset xo, one can transform such an ideal BIC into a quasi-BIC. This phenomenon has been explained from the view of the symmetry. This explanation is intuitive and concise to summarize the formation of the BIC, but hardly shows the process of the energy exchange from the bound modes to the external modes.

Taking Mode 1 as an example, the modes are then characterized via spherical and Cartesian multipolar analysis. This enables an observation from the view of multipolar transformations, manifesting itself as a Fano feature in the optical response spectrum.

Spherical and Cartesian multipolar analysis are performed for three different cases: x₀=120 nm, 135 nm and 150 nm, respectively. The ED, MD, EQ, MQ, EO, MO, py, and TD represent the electric dipole (ED) and magnetic dipole (MD), electric quadrupole (EQ) and magnetic quadrupole (MQ), electric octupole (EO) and magnetic octupole (MO), the electric dipole moment along the y-axis (py), and electric Toroidal moment (TD).

The sample was fabricated using standard electron beam lithography. The membrane metasurface is fabricated via etching an array of nano holes in the amorphous silicon film on a glass substrate.

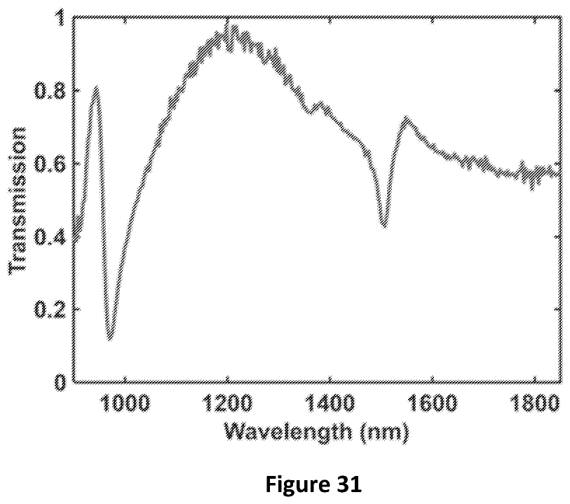

FIG. 31 is a plot of the measured linear transmission spectrum of the metasurface under a white light source illumination. Two pronounced asymmetric Fano line shapes are observed around λ=980 nm and λ=1510 nm, respectively. This indicates the excitation of the two quasi-BICs. The estimated widths of the two states are around 50 nm and 20 nm, respectively.

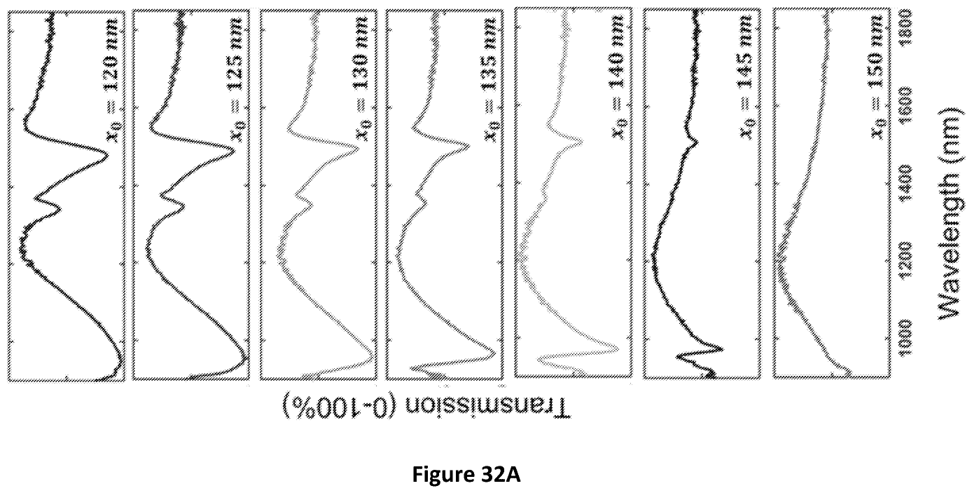

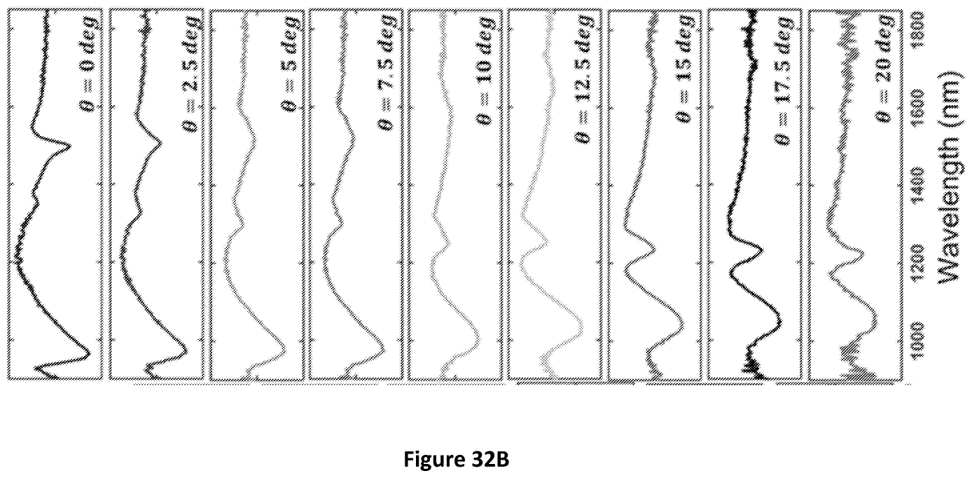

FIG. 32A shows the measured transmission spectra of metasurfaces designed with different offsets. The width of the resonance narrows as the offset increases from 120 nm to 150 nm. This corresponds to the decrease in geometric asymmetry. The Fano feature in the spectrum vanishes when x₀=150 nm, corresponding to the inaccessibility of the ideal BIC supported by the metasurface.

A slight redshift of the resonance is also observed along with another Fano resonance at around the wavelength of 1000 nm. Similarly, it vanishes when x₀=150 nm. By performing the multipolar analysis, one can conclude that this Fano resonance is mainly formed by the interference between the ED, EQ and MO resonances.

FIG. 32B shows the angular dependence of the transmission spectrum by changing the incident angle θ, of the y-polarised pump light along xz plane. With the increase of the incident angle θ, the redshift of the two resonances is observed.

Meanwhile, the resonance MR2 is blue shifted. This matches well with the calculated band structure.

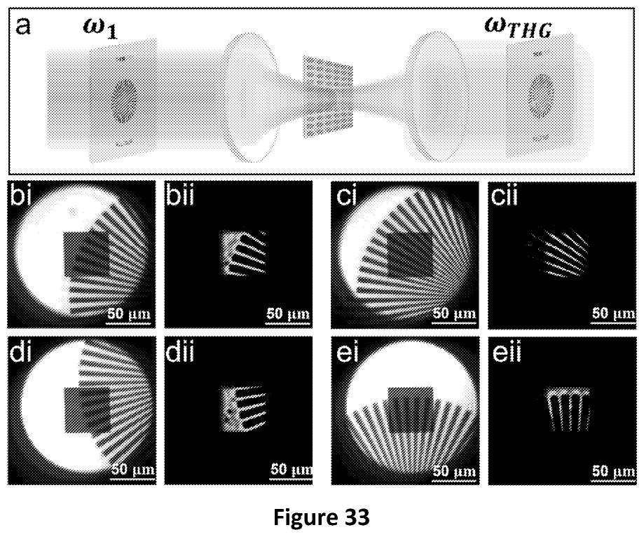

FIG. 33 illustrates THG imaging using a metasurface. This system is used to demonstrate experimentally the conversion of near-infrared image into visible based on the THG process in the membrane metasurfaces.

FIG. 33(a) is schematic diagram for THG imaging. A pump beam pass passes through a target (NBS 1963A resolution test target), which is then imaged by the focal lens onto the metasurface. A THG signal is then collected for measurement.

FIG. 33(bi-ci-di-ei) show the visible image when the metasurface is overlapped with the target at different positions under a white light source illumination. The metasurface sample (offset x₀=135 nm) is then overlapped with the image of the target near the focal plane and illuminated with a 1512-nm IR laser.

FIG. 33 (bii-cii-dii-eii) show the images captured by the CCD camera (CS165MU/M, Thorlabs). The pattern of the overlapping area between image of the target and the metasurfaces can be converted to visible images clearly. A clear multi-stripe pattern is obtained based on THG process.

The use of THG therefore allows performing infrared imaging without the need for an additional pump light.

The various structures/metasurfaces presented in the disclosure show the potential of various design to manipulate/enhance the efficiencies of THG or FWM. It will be appreciated that these embodiments can be modified to suit a particular application.

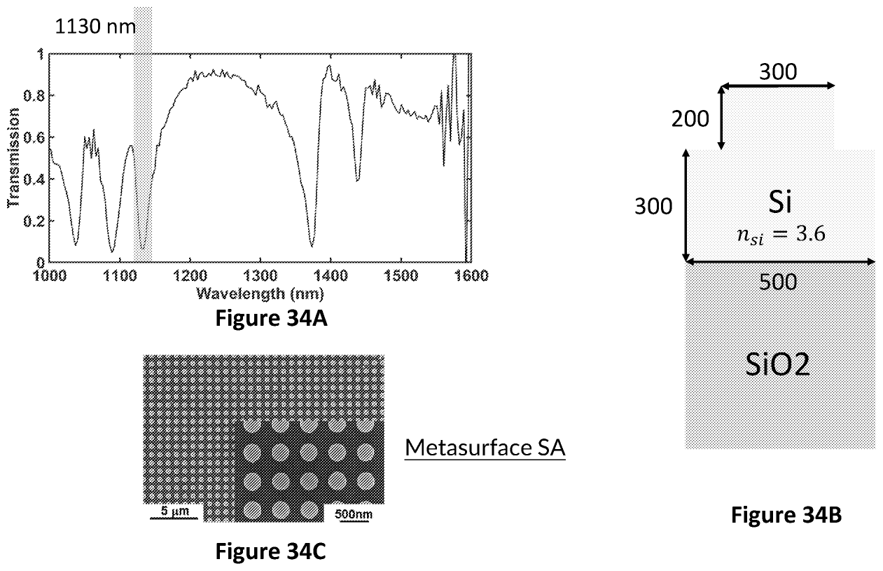

FIGS. 34 to 39 present various experimental results obtained with a frequency conversion device including an array of elements on a substrate as described in FIG. 17 with a slab-disk configuration.

FIG. 34A is a plot of the transmission spectra obtained with a frequency conversion device based on an array of nano disks formed on a slab (metasurface SA).

FIG. 34B is a cross sectional view of a nano disk on a slab provided on a substrate. The metasurface SA can be fabricated by regular electron beam lithography technique.

FIG. 34C shows a top image of the metasurface SA taken via electron microscopy.

In this example the frequency conversion device was fabricated out of commercial silicon on sapphire SoS substrate with silicon nano disks on top of silicon film. The height of silicon nano disks and silicon film are 200 nm and 300 nm, respectively. The diameter and centre-to-centre separation of the nano disks in this sample are 300 nm and 500 nm, respectively. The frequency conversion device exhibits several Mie-type resonances and guided resonances, making it suitable for third-order nonlinear imaging. In this particular case, the device is designed to be resonant at 1130 nm. A pump beam at 1130 nm has a of pump frequency ω₁ as shown in FIG. 4B (i) and (ii).

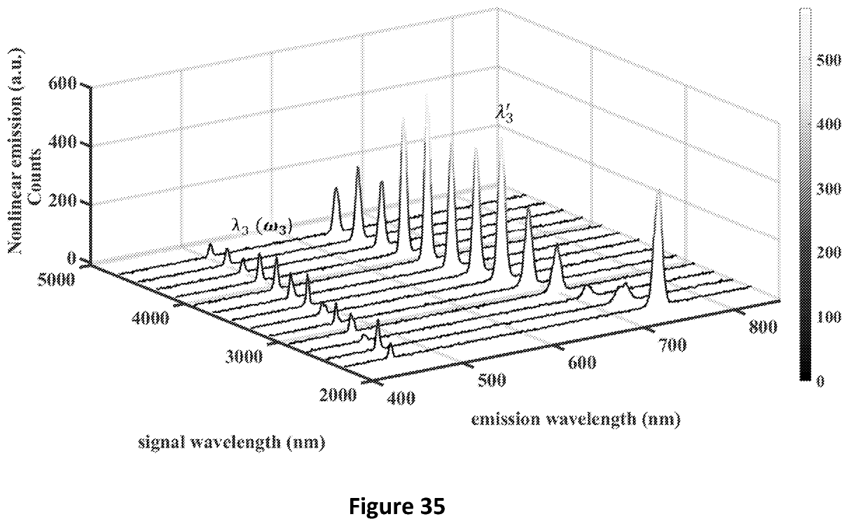

FIG. 35 shows the FWM emissions obtained for different values of signal frequencies. The FWM emission for third-order nonlinear imaging has a frequency ω₃ or ω₃ that can be generated using a pump beam of frequency ω₁ and signal beam of frequency ω₂ via type (i) and type (ii) FWM processes (shown in FIG. 4B). By changing the signal frequency ω₁, one can control the frequency of the FWM signal (ω₃ and/or ω₃′) emission. Also, multiple FWM emissions can be obtained. Some of the FWM processes are quadratically dependent on the pump intensity. One can boost the emission to a much higher level by controlling the pump power.

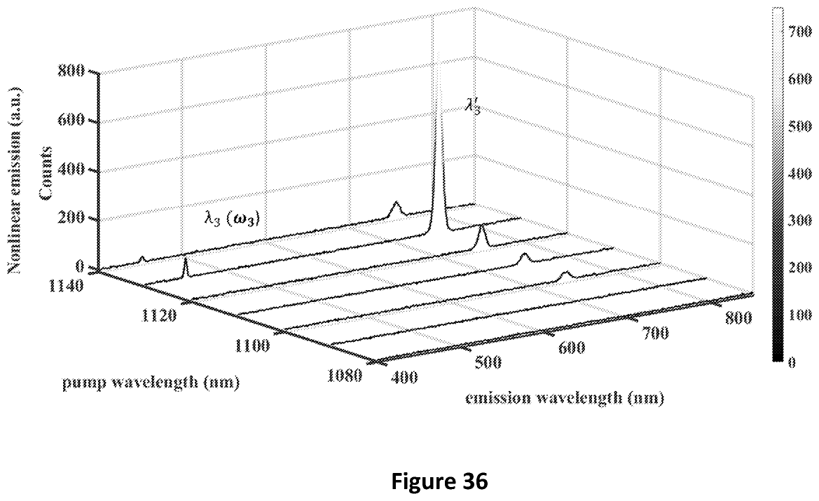

FIG. 36 shows the FWM emissions obtained for different values of pump frequencies. By changing the pump frequency ω₁, one can control the frequency of the FWM signal (ω₃ and/or ω₃′) emission.

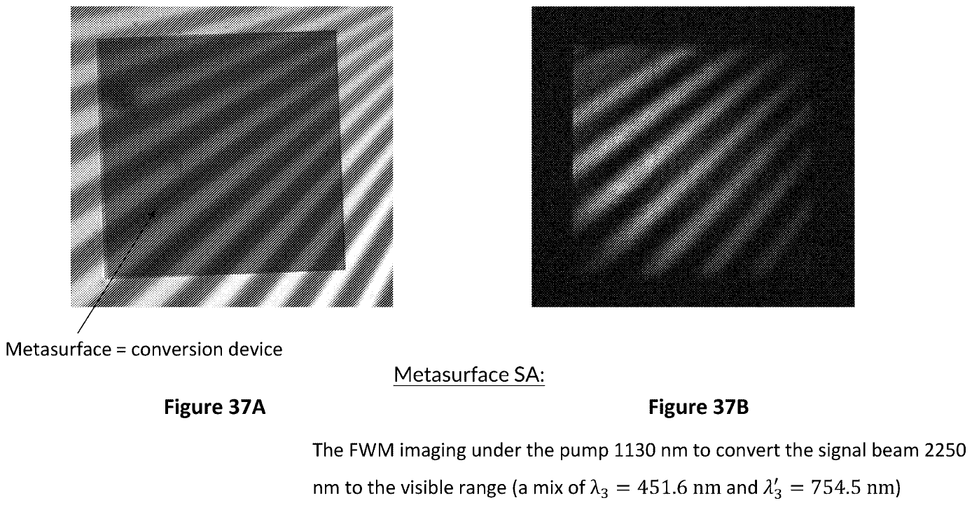

FIG. 37A shows an image of a target measured under white light illumination. The image is obtained using the setup of FIG. 3 but with a single white light source and no signal or pump beams. The detector 230 measures visible light passing through the target and through the frequency conversion device 210.

FIG. 37B shows an image of the same target measured using the set-up of FIG. 3 with a signal beam at 2250 nm and a pump beam at 1130 nm. The visible image of the target arises from visible light generated by the frequency conversion device 210 via FWM process as shown in FIG. 37A.

To demonstrate the effect of the FWM process alone for imaging, the THG frequency has been filtered out.

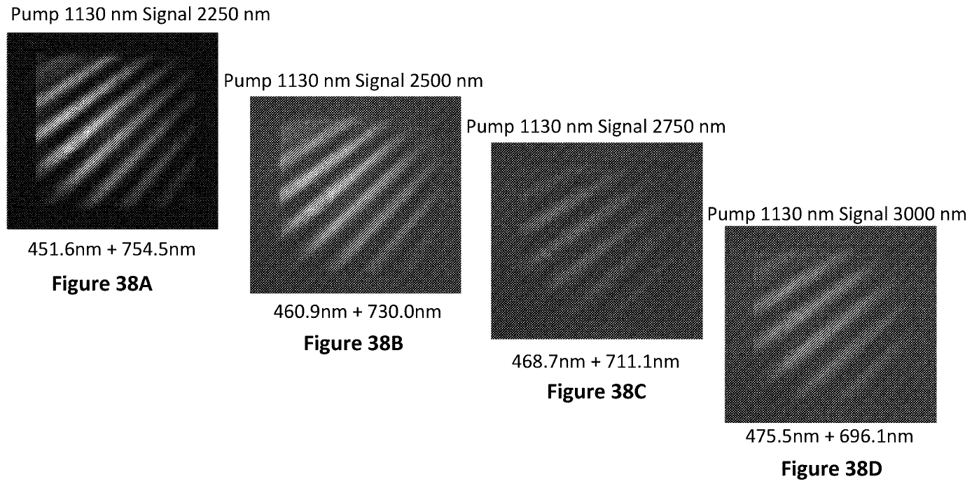

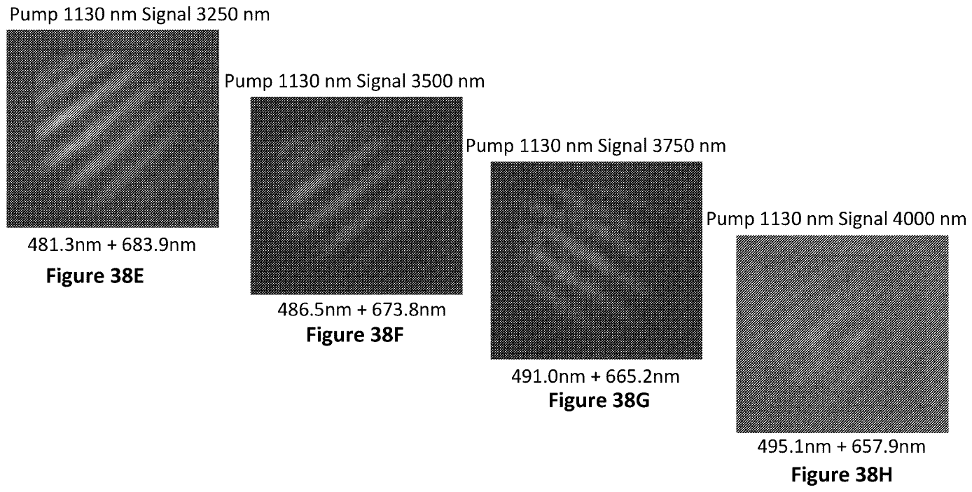

FIGS. 38A-38H show the images of a same target measured using the set-up of FIG. 3 with different combinations of signal and pump beams. To demonstrate the effect of FWM process alone for imaging, the THG frequency was filtered out.

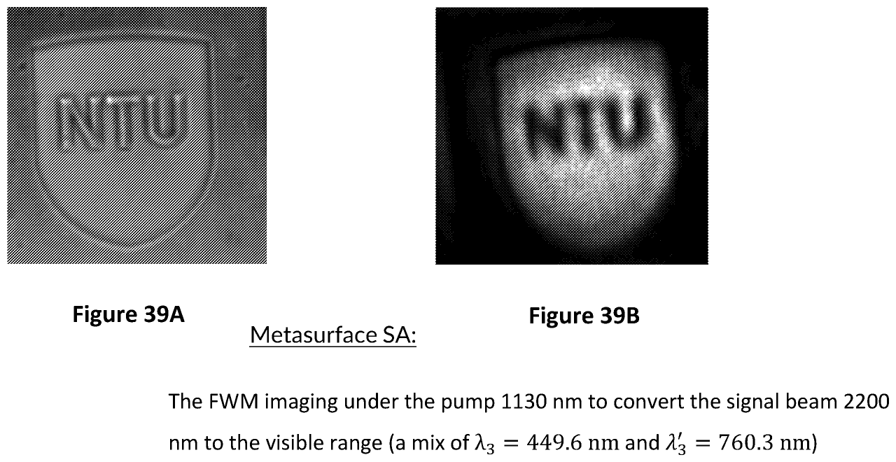

FIG. 39A shows an image of a target with ‘NTU’ marking measured under white light illumination. The image is obtained using the setup of FIG. 3 but with a single white light source and no signal or pump beams. The detector 230 measures visible light passing through the target and through the frequency conversion device 210.

FIG. 39B shows an image of the same target measured using the set-up of FIG. 3 with a signal beam at 2200 nm and a pump beam at 1130 nm. The visible image of the target arises from visible light generated by the frequency conversion device 210 via FWM process as shown in FIG. 39A. To demonstrate the effect of the FWM process alone for imaging, the THG frequency has been filtered out.

The metasurfaces described in the disclosure show a periodic arrangement of individual elements. However it will be appreciated that the separation between individual elements does not need to be mutual so that individual elements are randomly separated. Such metasurfaces are called disordered metasurfaces.

Similarly, the metasurfaces described in the disclosure show a periodic arrangement of individual elements having a same shape and a same size. However, it will be appreciated that metasurfaces can be designed with a structure that includes individual elements of different shape and sizes. Depending on the application, this approach can be used to control the phase of the output beam. A structure could also include multiple sets or regions of individual elements.

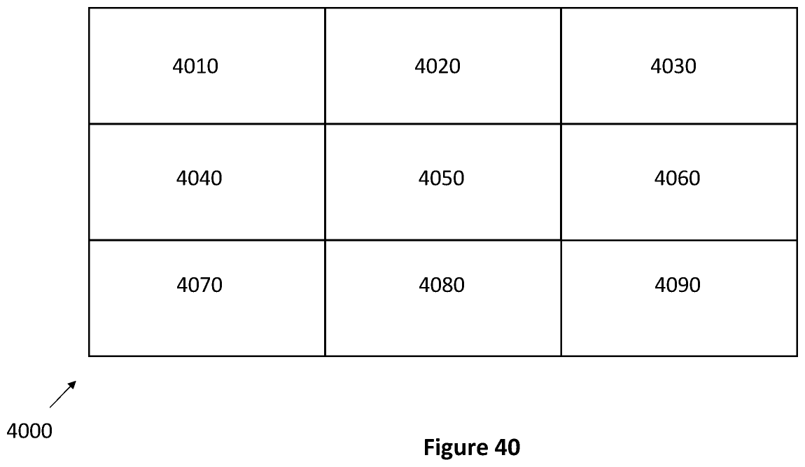

FIG. 40 shows a structure 4000 having several sets or regions of individual elements. Each set or region represent a single sub-metasurface, having its own characteristics. In this example nine sub-metasurfaces are represented and labelled 4010-4090.

Each sub-metasurface can have different types of individual elements. Each individual element within a sub-metasurface can have a same shape and a same size. The shape and size of individual elements can therefore be different for different sub-metasurfaces. Alternatively, the individual elements within a sub-metasurface can have different shape and sizes. Depending on the application one or more of the sub-metasurfaces can be the same; or they could all be different.

In FIG. 40 the nine sub-metasurfaces 4010-4090 have a rectangular shape and are juxtaposed next to one another. It will be appreciated that the sub-metasurfaces can be designed with other geometrical shapes and arranged in a tessellated fashion. For instance, the sub-metasurfaces can have a polygonal shape.

It will also be appreciated that depending on the application and design of the metasurface, the output beam can have one or more wavelengths of less than about 1000 nm obtained via one or more nonlinear processes such as four wave mixing or higher order mixing nonlinear processes.

A skilled person will therefore appreciate that variations of the disclosed arrangements are possible without departing from the disclosure. Accordingly, the above description of the specific embodiments is made by way of example only and not for the purposes of limitation. It will be clear to the skilled person that minor modifications can be made without significant changes to the operation described.

1.-25. (canceled)

26. A frequency conversion device for use with a detector for imaging a sample, the frequency conversion device comprising:
a structure made of a third-order susceptibility material adapted to convert a first beam of electromagnetic radiation having a first wavelength in the infrared region into an output beam having at least two wavelengths of less than about 1000 nm via a four-wave mixing or higher-order mixing nonlinear process,
wherein the structure comprises an arrangement of individual elements, and
wherein the third-order susceptibility material is adapted to generate the output beam by mixing the first beam with at least one of a first pump beam having a second wavelength and a second pump beam having a third wavelength.

27. The frequency conversion device as claimed in claim 26, wherein at least one of the second wavelength of the first pump beam and the third wavelength of the second pump beam is greater than about 1000 nm.

28. The frequency conversion device as claimed in claim 26, wherein each individual element of the arrangement of individual elements has a nano scale or a micro scale.

29. The frequency conversion device as claimed in claim 26, wherein the arrangement of individual elements is a periodic arrangement and/or the arrangement of individual elements supports resonant light-matter interaction.

30. The frequency conversion device as claimed in claim 26, wherein the individual elements are holes formed within a layer of third-order susceptibility material, or the individual elements are nano or micro elements formed of a third-order susceptibility material.

31. The frequency conversion device as claimed in claim 25, wherein the individual elements are provided on a substrate.

32. The frequency conversion device as claimed in claim 26,
wherein the structure comprises several layers of individual elements; and/or
wherein the structure comprises multiple regions of individual elements.

33. The frequency conversion device as claimed in claim 26, wherein the third-order susceptibility material comprises at least one material selected from the group consisting of: a dielectric material, a semiconductor material, an oxide-based material, a transition metal dichalcogenide material, and a nitride-based material.

34. The frequency conversion device as claimed in claim 26, wherein the frequency conversion device has an active area greater than or equal to 20 μm×20 μm.

35. The frequency conversion device as claimed in claim 26, wherein the individual elements within the arrangement have a same shape and a same size or the individual elements within the arrangement have different shapes and sizes.

36. An imaging system for imaging a sample, the system comprising the frequency conversion device as claimed in claim 1;
an optical arrangement configured to collect the first beam of electromagnetic radiation having the first wavelength in the infrared region and to direct the first beam onto the frequency conversion device to generate the output beam of radiation; wherein the first beam of electromagnetic radiation passes through or arises from the sample; and
a detector configured to detect the output beam of radiation to obtain an image of the sample.

37. The imaging system as claimed in claim 36, further comprising:
one or more radiation sources adapted to generate the first pump beam of electromagnetic radiation having the second wavelength and/or the second pump beam of electromagnetic radiation having the third wavelength.

38. The imaging system as claimed in claim 36, wherein the frequency conversion device is configured to resonate at one or more of: the first wavelength of the first beam, the second wavelength of the first pump beam, the third wavelength of the second pump beam, and a wavelength of the output beam.

39. The imaging system as claimed in claim 36, wherein the system forms a sensor adapted to sense visible, near-infrared, and/or mid-infrared radiations.

40. A method of imaging a sample, the method comprising:
providing a frequency conversion device having a structure made of a third-order susceptibility material adapted to convert a first beam of electromagnetic radiation having a first wavelength in the infrared region into an output beam having at least two wavelengths of less than about 1000 nm via a four-wave mixing or higher-order mixing nonlinear process,
wherein the structure comprises an arrangement of individual elements, and
wherein the third-order susceptibility material is adapted to generate the output beam by mixing the first beam with at least one of a first pump beam having a second wavelength and a second pump beam having a third wavelength;
collecting the first beam of electromagnetic radiation,
wherein the first beam of electromagnetic radiation passes through or arises from the sample;
directing the first beam onto the frequency conversion device to generate the output beam of radiation; and
detecting the output beam of radiation to obtain an image of the sample.

41. The method as claimed in claim 40, further comprising:
generating the first pump beam of electromagnetic radiation having the second wavelength; and
mixing the first beam and the first pump beam using the frequency conversion device to obtain the output beam.

42. The method as claimed in claim 40, further comprising:
generating the second pump beam of electromagnetic radiation having the third wavelength; and
mixing the first beam, the first pump beam, and the second pump beam using the frequency conversion device to obtain the output beam.

43. The method as claimed in claim 40, further comprising:
varying the second wavelength and/or the third wavelength to adjust a wavelength and intensity of the output beam.

44. The method as claimed in claim 40,
wherein the third-order susceptibility material is configured to generate a nonlinear signal, and
wherein the nonlinear signal is a degenerate four-wave mixing emission or a non-degenerate four-wave mixing emission.

45. A method comprising:
imaging a sample with a frequency conversion device,
wherein the frequency conversion device comprises a structure made of a third-order susceptibility material adapted to convert a first beam of electromagnetic radiation having a first wavelength in the infrared region into an output beam having at least two wavelengths of less than about 1000 nm via a four-wave mixing or higher-order mixing nonlinear process,
wherein the structure comprises an arrangement of individual elements, and
wherein the third-order susceptibility material is adapted to generate the output beam by mixing the first beam with at least one of a first pump beam having a second wavelength and a second pump beam having a third wavelength.
